(19) United States
(12) Patent Application Publication
(10) Pub. No.: US 2025/0269499 A1
(43) Pub. Date: Aug. 28, 2025

(54) SCREW DRIVING MACHINE

(71) Applicant: Max Co., Ltd., Tokyo (JP)

(72) Inventor: Kazuya Mochizuki, Tokyo (JP)

(21) Appl. No.: 19/065,502

(22) Filed: Feb. 27, 2025

(30) Foreign Application Priority Data
Feb. 28, 2024 (JP) 2024-027976

(51) Int. Cl. B25B 21/00; B25B 23/00

(52) U.S. Cl. CPC B25B 21/00; B25B 23/0064

(57) ABSTRACT

There is provided a screw driving machine including: a first arm supported movably along the axial direction thereof and that comes into contact with a driven member; a second arm supported movably along the axial direction and that causes the start valve to operate; a transmission member that transmits movement of the first arm to the second arm such that the first arm moves in conjunction with the second arm; a guide portion that guides movement of the transmission member and switches whether the first arm moves in conjunction with the second arm; a biasing member that biases the transmission member; and a biasing force switching portion that regulates a biasing force of the biasing member against the transmission member and switches a strength of the biasing force of the biasing member in accordance with a position of the transmission member guided by the guide portion.

### CROSS-REFERENCE TO RELATED APPLICATIONS

This application is based on and claims priority under 35 USC 119 from Japanese Patent Application No. 2024-027976 filed on Feb. 28, 2024, the contents of which are incorporated herein by reference.

### TECHNICAL FIELD

The present disclosure relates to a screw driving machine that performs tightening after driving a screw into a driven member.

### BACKGROUND ART

A screw driving machine is a tool that operates by using compressed air as a power source, causes a driver bit to move in an axial direction to drive a screw such that a head portion of the screw is lifted from a driven member, and then cause the driver bit to rotate to tighten the screw to the driven member.

In such a screw driving machine, when the screw is driven, a tip of the screw needs to be driven to penetrate an upper material of the driven member and to a middle of a lower material thereof. However, when the screw is excessively driven, a hole larger than a screw diameter is deeply bored in the lower material, and thus there is a possibility that an engagement amount of the screw is short and a fastening force is weakened.

Therefore, a mechanism has been proposed in which a slide member called a contact arm or the like that slides along an axis of an ejection portion that guides a driver bit and a screw is provided on a tip end side of the ejection portion, and an engaging unit is provided that biases a tip end of the slide member so as always to protrude, engages with the slide member when the screw is driven, and releases the engagement when the screw is tightened, thereby reducing a driving depth of the screw and tightening the screw to a position where a head portion of the screw is flush with an upper material of a driven member when the screw is tightened (for example, see JP3570485B2).

However, in a configuration of the two-stage stroke system in which the slide member is engaged with the engaging unit at the time of driving the screw to stop the movement of the slide member in the middle, and the engagement by the engaging unit is released at the time of tightening the screw to allow the slide member to further move, a movement amount of the slide member becomes longer, and the entire length of the device becomes longer.

Therefore, a mechanism has been proposed in which a movement amount of a slide member can be reduced by dividing a slide member into an upper arm portion and a lower arm portion (for example, see JP3632296B2).

In order to switch whether a lower arm portion moves in conjunction with an upper arm portion, a mechanism has been proposed in which by transmitting the movement of the lower arm portion to the upper arm portion via a roller and guiding a moving direction of the roller, a state where the lower arm portion moves in conjunction with the upper arm portion and a state where the conjunction is released and the lower arm portion moves independently of the upper arm portion are switched.

In such a configuration, the roller is biased by a biasing member so that the roller can move in a predetermined direction.

However, a biasing force for biasing the roller acts on the lower arm portion and the upper arm portion via the roller, thereby increasing a load in an operation of moving the lower arm portion and the upper arm portion.

### SUMMARY OF INVENTION

The present disclosure provides a screw driving machine capable of reducing an increase in a load in an operation of moving a contact arm in a configuration in which a contact arm is divided into two.

According to an illustrative aspect of the present disclosure, a screw driving machine includes: a driving portion to which compressed air is supplied and configured to cause a driver bit to move in an axial direction of the driver bit; a tightening portion to which the compressed air is supplied and configured to cause the driver bit to rotate around an axis; a main valve configured to switch whether the compressed air is supplied to the driving portion and the tightening portion; a start valve that causes the main valve to operate; a first arm supported movably along the axial direction of the driver bit and configured to come into contact with a driven member; a second arm supported movably along the axial direction of the driver bit and configured to cause the start valve to operate; a transmission member configured to move to a position where movement of the first arm can be transmitted to the second arm and the first arm moves in conjunction with the second arm, and move to a position where the movement of the first arm is not transmitted to the second arm to release conjunction between the first arm and the second arm; a guide portion configured to guide movement of the transmission member and switch whether the first arm moves in conjunction with the second arm in accordance with a position of the transmission member that is being guided; a biasing member configured to bias the transmission member toward a position where the movement of the first arm can be transmitted to the second arm; and a biasing force switching portion configured to regulate a biasing force of the biasing member against the transmission member and switch a strength of the biasing force of the biasing member in accordance with a position of the transmission member guided by the guide portion.

In the present disclosure, the first arm is pressed against the driven member, and the transmission member moves in conjunction with the movement of the first arm. The transmission member moves while being guided by the guide portion. When the transmission member moves while being guided by the guide portion, the conjunction between the first arm and the second arm is switched.

When the first arm moves in conjunction with the second arm and the second arm causes the start valve to operate, the main valve operates, the compressed air is supplied to the driving portion, and the driver bit moves in the axial direction, whereby the screw is driven into the driven member. Further, the compressed air is supplied to the tightening portion, the driver bit rotates around the axis, and the screw driven into the driven member is tightened.

Further, when the conjunction between the first arm and the second arm is released, the first arm can move in conjunction with the tightening of the screw, and the second arm does not move in conjunction with the first arm.

The biasing member biases the transmission member in a direction in which the transmission member moves to the position where the movement of the first arm can be transmitted to the second arm. On the other hand, the strength of the biasing force of the biasing member against the transmission member is switched in accordance with the position of the transmission member guided by the guide portion. A biasing force of the biasing member against the transmission member in an operation in which the first arm is pressed against the driven member and the first arm moves in conjunction with the second arm is weakened as compared with in an operation in which the conjunction between the first arm and the second arm is released and the first arm moves.

In the present disclosure, in an operation in which the first arm is pressed against the driven member, it is possible to reduce a load generated by the transmission member being biased by the biasing member. Further, by the operation of moving the transmission member to the position where the movement of the first arm can be transmitted to the second arm, the transmission member can reliably move by the biasing by the biasing member.

### BRIEF DESCRIPTION OF DRAWINGS

FIG. 1A is a side sectional view illustrating an example of a screw driving machine according to the present embodiment;

FIG. 1B is a front sectional view illustrating the example of the screw driving machine according to the present embodiment;

FIG. 1C is a side view illustrating the example of the screw driving machine according to the present embodiment;

FIG. 1D is a side view illustrating the example of the screw driving machine according to the present embodiment;

FIG. 2A is a side sectional view of main parts illustrating the example of the screw driving machine according to the present embodiment;

FIG. 2B is a perspective view of main parts illustrating the example of the screw driving machine according to the present embodiment;

FIG. 2C is a perspective view of main parts illustrating the example of the screw driving machine according to the present embodiment;

FIG. 2D is a perspective view of main parts illustrating the example of the screw driving machine according to the present embodiment;

FIG. 2E is a sectional view illustrating an example of a transmission member;

FIG. 2F is sectional view illustrating an example of the transmission member;

FIG. 3A is a side view illustrating an example of a lower arm;

FIG. 3B is a side view illustrating an example of an upper arm;

FIG. 3C is a side view illustrating an example of a switching member;

FIG. 3D is a side view illustrating an example of a biasing force transmission member;

FIG. 4A is a side sectional view of main parts of the screw driving machine according to the present embodiment illustrating an example of the operation of driving a screw into a driven member and tightening the screw;

FIG. 4B is a side sectional view of main parts of the screw driving machine according to the present embodiment illustrating an example of the operation of driving the screw into the driven member and tightening the screw;

FIG. 5A is a side sectional view of main parts illustrating an example of the screw driving machine according to the present embodiment including a driving depth switching portion of a screw;

FIG. 5B is a side sectional view of main parts illustrating an example of the screw driving machine according to the present embodiment including the driving depth switching portion of the screw;

FIG. 5C is a side view illustrating an example of the screw driving machine according to the present embodiment including the driving depth switching portion of the screw;

FIG. 5D is a bottom sectional view of main parts illustrating an example of the screw driving machine according to the present embodiment including the driving depth switching portion of the screw;

FIG. 5E is a bottom sectional view of main parts illustrating an example of the screw driving machine according to the present embodiment including the driving depth switching portion of the screw;

FIG. 6 is a perspective view of main parts illustrating an example of the screw driving machine according to the present embodiment including the driving depth switching portion of the screw;

FIG. 7A is a side view illustrating an example of the lower arm of the screw driving machine including the driving depth switching portion;

FIG. 7B is a side view illustrating an example of the switching member of the screw driving machine including the driving depth switching portion;

FIG. 8A is a side sectional view of main parts of the screw driving machine according to the present embodiment illustrating an example of the operation of driving the screw into the driven member and tightening the screw in a state where a first mode is selected;

FIG. 8B is a side sectional view of main parts of the screw driving machine according to the present embodiment illustrating an example of the operation of driving the screw into the driven member and tightening the screw in the state where the first mode is selected; and

FIG. 9 is a side sectional view of main parts of the screw driving machine according to the present embodiment illustrating an example of the operation of driving the screw into the driven member and tightening the screw in a state where a second mode is selected.

### DESCRIPTION OF EMBODIMENTS

Hereinafter, an embodiment of a screw driving machine according to the present invention will be described with reference to the drawings.

### Configuration Example of Screw Driving Machine according to Present Embodiment

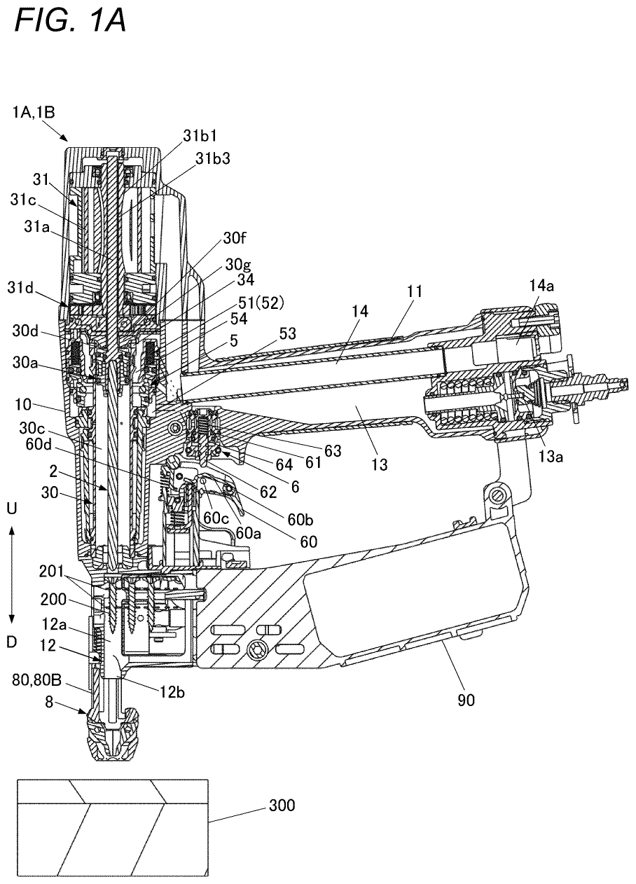

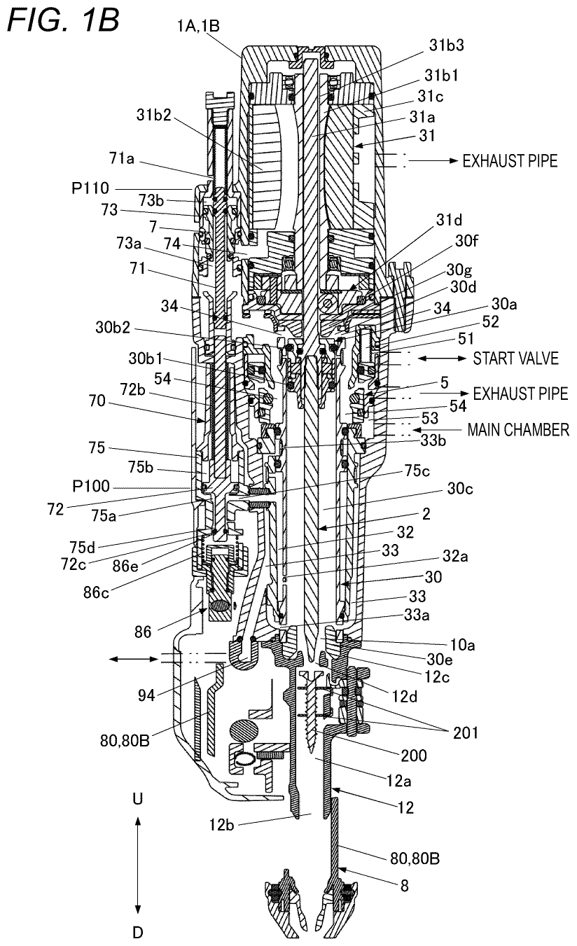

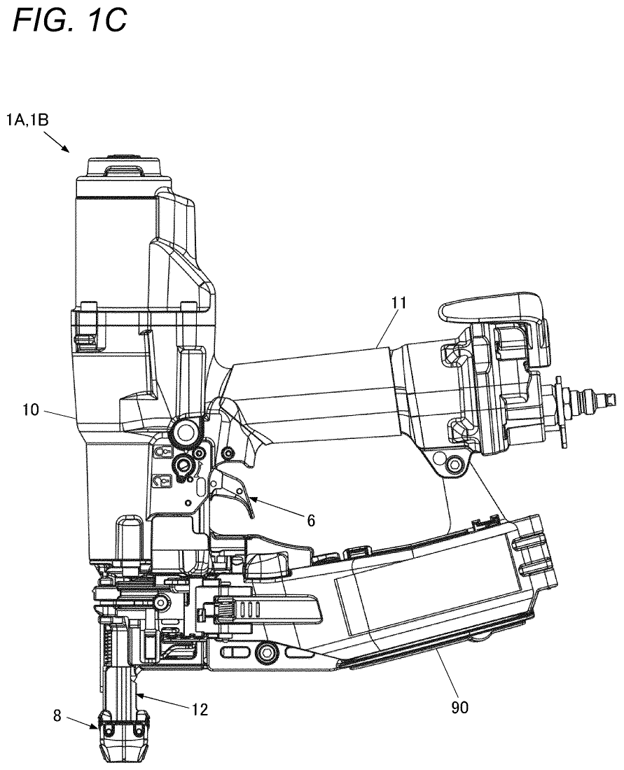

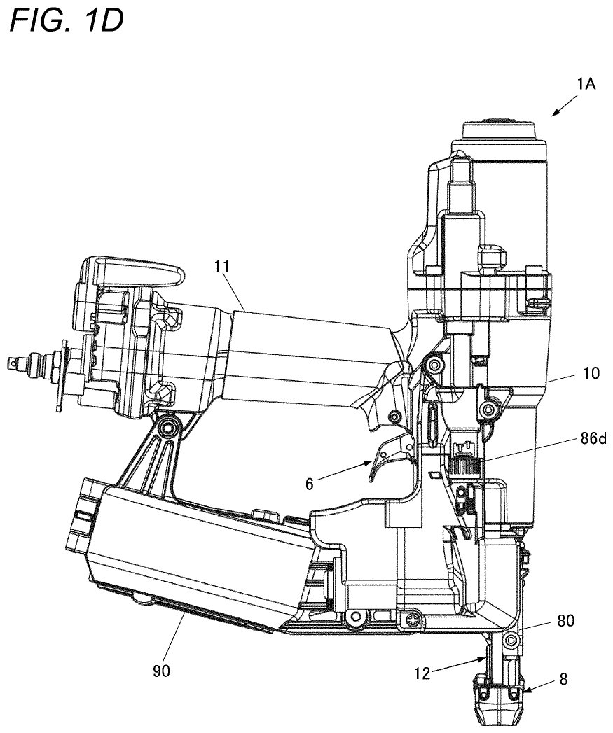

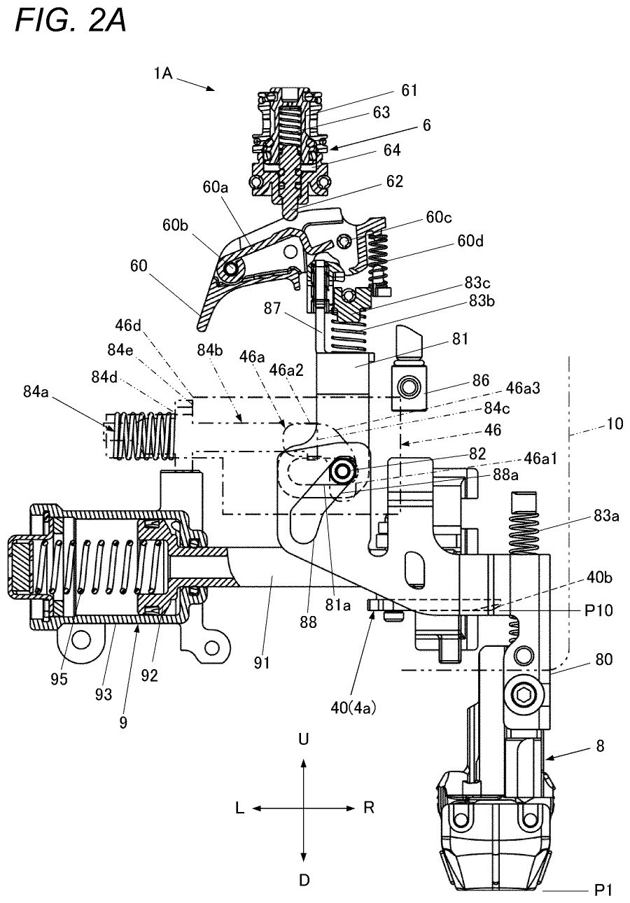

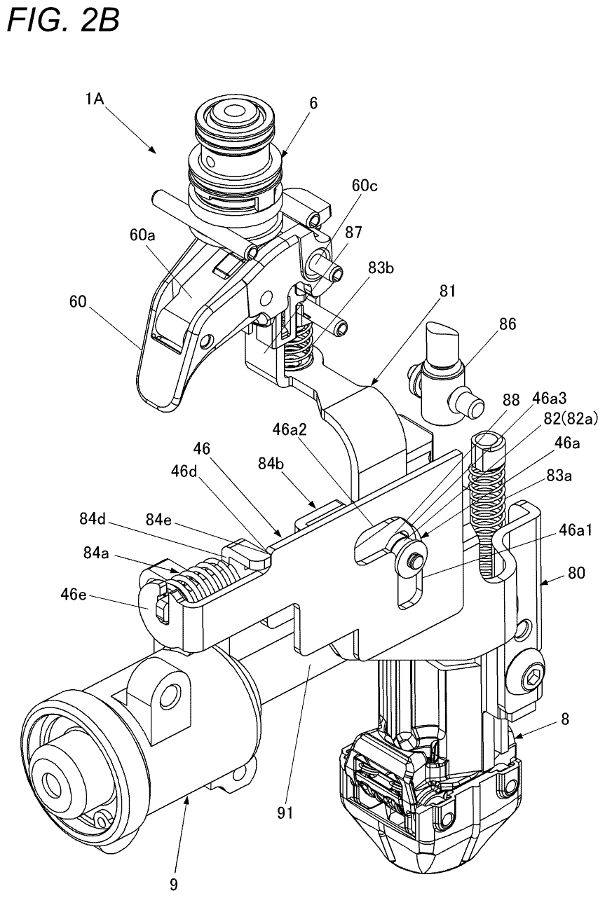

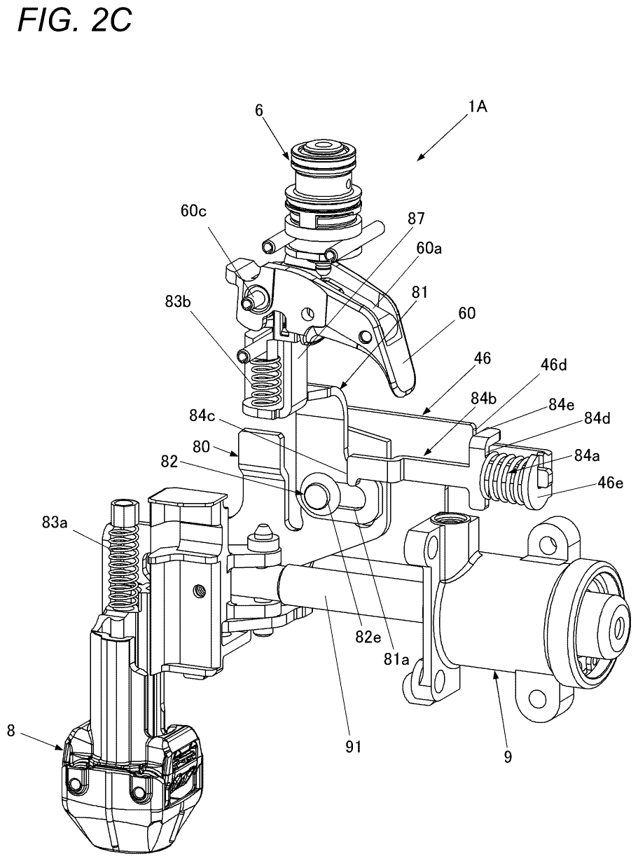

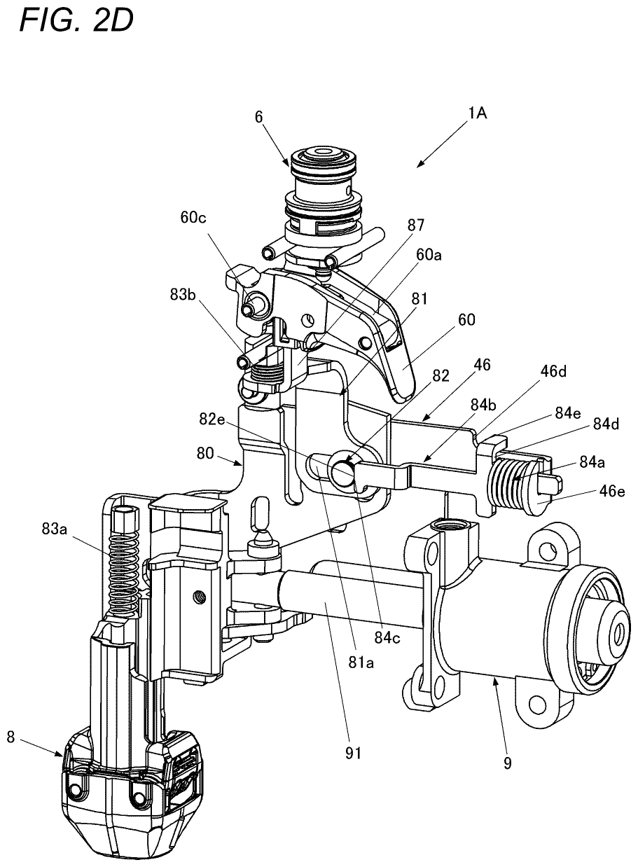

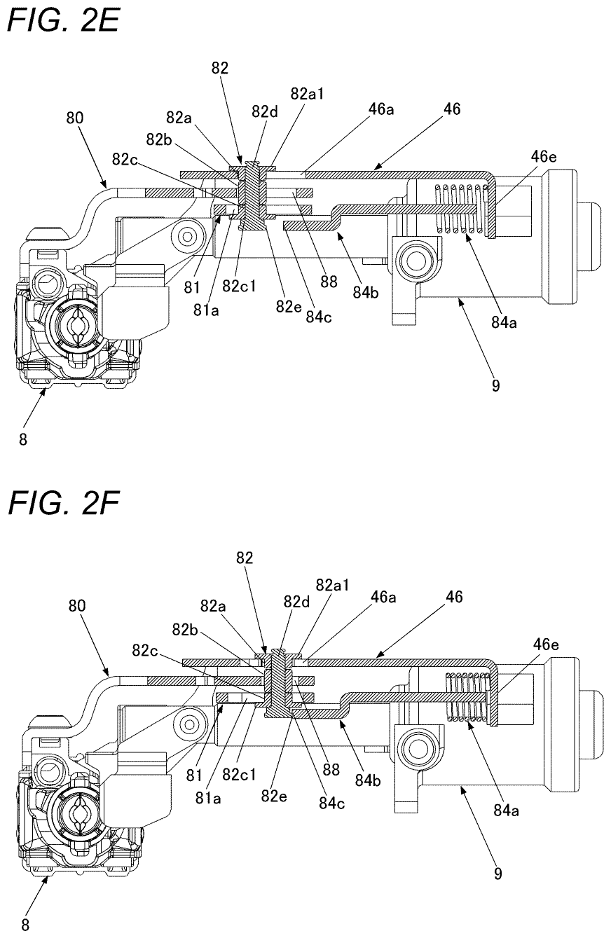

FIG. 1A is a side sectional view illustrating an example of a screw driving machine according to the present embodiment, FIG. 1B is a front sectional view illustrating an example of the screw driving machine according to the present embodiment, and FIGS. 1C and 1D are side views illustrating an example of the screw driving machine according to the present embodiment. FIG. 2A is a side sectional view of main parts illustrating an example of the screw driving machine according to the present embodiment, and FIGS. 2B, 2C, and 2D are perspective views of main parts illustrating an example of the screw driving machine according to the present embodiment.

The screw driving machine 1A causes a driver bit 2 to move in an axial direction using air pressure of compressed air. Further, the screw driving machine 1A rotates the driver bit 2 around an axis using the air pressure of the compressed air. By causing the driver bit 2 to move in the axial direction, the screw driving machine 1A drives a screw 200 into a driven member 300 such that a head portion of the screw 200 floats from the driven member 300. In addition, the screw driving machine 1A rotates the driver bit 2 around the axis to tighten the screw 200 driven into the driven member 300.

The screw driving machine 1A is used by being held by a hand of a person and includes a body 10 and a handle 11. The body 10 extends along an axial direction of the driver bit 2.

In the screw driving machine 1A, the handle 11 is provided in the vicinity of the middle along an extending direction of the body 10. The handle 11 extends in a direction intersecting the body 10. Further, in the screw driving machine 1A, the nose 12 is provided on one side along the extending direction of the body 10.

As illustrated in FIG. 1A and the like, the screw driving machine 1A is illustrated in a form in which the nose 12 faces downward, and thus one side along the extending direction of the body 10 is referred to as a lower side, and the other side along the extending direction of the body 10 is referred to as an upper side. In the screw driving machine 1A, a downward direction is indicated by an arrow D. In the screw driving machine 1A, an upward direction opposite to the downward direction is indicated by an arrow U. The driver bit 2 has an axial direction oriented along an up-down direction, and moves in the downward direction and the upward direction.

The nose 12 includes an injection passage 12a to which the screw 200 is supplied, an injection port 12b from which the screw 200 supplied to the injection passage 12a is injected, and a blocking portion 12c that blocks a lower end of the body 10. In the screw driving machine 1A, the body 10 and the nose 12 are separate components. The body 10 is open at the lower end, and an opening 10a is formed at the lower end. The opening 10a has a shape through which the driver bit 2 can pass. In the nose 12, the blocking portion 12c is attached to the lower end of the body 10. The blocking portion 12c blocks the opening 10a in a form through which the driver bit 2 can pass.

The injection passage 12a extends along the up-down direction in which the driver bit 2 moves. The injection port 12b is formed to have an opening at a lower end along an extending direction of the injection passage 12a. The blocking portion 12c includes an introduction portion 12d through which the driver bit 2 passes. The introduction portion 12d is formed to have an opening at an upper end along the extending direction of the injection passage 12a. The blocking portion 12c is formed on an outer peripheral side of the introduction portion 12d.

The screw driving machine 1A includes a driving cylinder 30 that causes the driver bit 2 to move in the axial direction, and a driving piston 30a that moves by the air pressure of the compressed air supplied to the driving cylinder 30.

The screw driving machine 1A includes an air motor 31 that rotates the driver bit 2 around an axis, and a motor shaft 31a that rotates by the air pressure of the compressed air supplied to the air motor 31.

The driving cylinder 30 is an example of a driving portion, and is provided inside the body 10 and includes a cylindrical space extending in the up-down direction.

The driving cylinder 30 is internally provided with the driving piston 30a. The driving piston 30a has a circular plate shape, a cylindrical shape, or the like that can move inside the driving cylinder 30 along the up-down direction.

The driving piston 30a is attached such that the motor shaft 31a protrudes upward. The driving piston 30a is detachably attached via the motor shaft 31a such that the driver bit 2 protrudes downward.

In the screw driving machine 1A, the driving piston 30a moves in the up-down direction inside the driving cylinder 30, so that the driver bit 2 and the motor shaft 31a move in the arrow D direction and the arrow U direction along the axial direction of the driver bit 2. In the screw driving machine 1A, the driver bit 2 rotates around the axis of the driver bit 2 as the motor shaft 31a rotates.

Accordingly, in the screw driving machine 1A, the driving piston 30a moves the driver bit 2 in the downward direction indicated by the arrow D along the axial direction by the air pressure of the compressed air supplied to the driving cylinder 30, and the screw 200 is driven into the driven member. In the screw driving machine 1A, the motor shaft 31a rotates the driver bit 2 around the axis by the air pressure of the compressed air supplied to the air motor 31, and the screw 200 is tightened into the driven member.

A first seal portion 30b1 and a second seal portion 30b2 are attached to an outer periphery of the driving piston 30a. The first seal portion 30b1 and the second seal portion 30b2 are provided with a predetermined interval therebetween at two positions along a direction in which the driving piston 30a moves. The first seal portion 30b1 is provided on a lower side along the direction in which the driving piston 30a moves, and the second seal portion 30b2 is provided on an upper side along the direction in which the driving piston 30a moves. The first seal portion 30b1 and the second seal portion 30b2 protrude from the outer periphery of the driving piston 30a and come into contact with an inner peripheral surface of the driving cylinder 30. Further, the first seal portion 30b1 and the second seal portion 30b2 slide on the inner peripheral surface of the driving cylinder 30 when the driving piston 30a moves in the up-down direction.

Accordingly, the interior of the driving cylinder 30 is partitioned by the driving piston 30a, and the airtightness between a space on an upper side of the driving piston 30a and a space on a lower side of the driving piston 30a is maintained by the first seal portion 30b1 and the second seal portion 30b2.

In the driving cylinder 30, a first chamber 30c is formed on a low side of the driving piston 30a, and a second chamber 30d is formed on an upper side of the driving piston 30b. The first chamber 30c is an example of a driving cylinder lower chamber, and is a space on the low side of the driving piston 30a. The second chamber 30d is an example of a driving cylinder upper chamber, and is a space on the upper side of the driving piston 30a.

In the driving cylinder 30, a lower end of the first chamber 30c is blocked by the blocking portion 12c of the nose 12. The driving cylinder 30 includes a bumper 30e at the lower end of the first chamber 30c. The bumper 30e is formed of an elastic body and is attached to the blocking portion 12c. The bumper 30e has an annular shape with which the driving piston 30a can come into contact. Further, in the bumper 30e, an opening in a central portion is connected to the introduction portion 12d of the blocking portion 12c, and the driver bit 2 can pass through the opening in the central portion. The driving piston 30a is movable in the downward direction to a position in contact with the bumper 30e. In the driving piston 30a and the driver bit 2, a position where the driving piston 30a comes into contact with the bumper 30e is a bottom dead center position. The bumper 30e is elastically deformable, and the bottom dead center positions of the driving piston 30a and the driver bit 2 move within a range in which the bumper 30e is elastically deformable.

In the screw driving machine 1A, a wall portion 30f is provided between the driving cylinder 30 and the air motor 31, and an upper end of the second chamber 30d is closed by the wall portion 30f. The driving cylinder 30 includes a bumper 30g at the upper end of the second chamber 30d. The bumper 30g is formed of an elastic body and is attached to the wall portion 30f. The bumper 30g has an annular shape with which the driving piston 30a can come into contact. In the bumper 30g, the motor shaft 31a can pass through the opening in the central portion. The driving piston 30a is movable in the upward direction to a position in contact with the bumper 30g. In the driving piston 30a and the driver bit 2, a position where the driving piston 30a comes into contact with the bumper 30g is a top dead center position. The bumper 30g is elastically deformable, and the top dead center positions of the driving piston 30a and the driver bit 2 move within a range in which the bumper 30g is elastically deformable.

The air motor 31 is an example of a tightening portion. The air motor 31 includes a rotor 31b1 that rotates when the compressed air is supplied, a blade 31b2 that receives a flow of air for causing the rotor 31b1 to rotate, and a motor housing 31c that rotatably supports the rotor 31b1 and generates the flow of air for causing the rotor 31b1 to rotate. In the air motor 31, the motor shaft 31a is inserted into a hole 31b3 provided in the rotor 31b1. In the air motor 31, rotation of the rotor 31b1 is transmitted to the motor shaft 31a via a speed reducer 31d. The speed reducer 31d is constituted by, for example, a planetary gear mechanism, and is provided between the driving cylinder 30 and the air motor 31.

The motor shaft 31a is supported movably in the axial direction with respect to the speed reducer 31d. Accordingly, the motor shaft 31a moves in the up-down direction integrally with the driving piston 30a and the driver bit 2.

When the rotor 31b1 of the air motor 31 rotates, the motor shaft 31a rotates at a predetermined reduction ratio via the speed reducer 31d.

The air motor 31 is provided on an upper side of the driving cylinder 30. The motor shaft 31a is provided coaxially with the driver bit 2. Accordingly, the air motor 31 is provided on the upper side of the body 10 coaxially with the driving cylinder 30. The air motor 31 is configured such that the motor shaft 31a is inserted into the hole portion 31b3 provided in the rotor 31b1, and thus a space in which the motor shaft 31a moves in the up-down direction is secured.

In addition, the screw driving machine 1A includes a main valve 5 that switches whether the compressed air is to be supplied to the driving cylinder 30 and air motor 31, a start valve 6 that causes the main valve 5 to operate, and a trigger 60 that causes the start valve 6 to operate. Further, the screw driving machine 1A includes an on-off valve 7 that switches whether the compressed air is to be supplied to the air motor 31 and a controller 70 that causes the on-off valve 7 to operate.

Further, the screw driving machine 1A includes the contact arm 8. The contact arm 8 is provided to be movable with respect to the body 10, enables the start valve 6 to operate in cooperation with the operation of the trigger 60, and causes the controller 70 to operate. In addition, the screw driving machine 1A includes a driving depth regulating portion 4a that restricts the relative movement of the contact arm 8 with respect to the body 10 and releases the restriction in an operation in which the contact arm 8 and the body 10 move relative to each other, and restricts a driving depth of the screw 200 with respect to the driven member 300.

In addition, the screw driving machine 1A includes a screw feeding portion 9 that feeds the screw 200 to the nose 12 and a magazine 90 that accommodates the screw 200 fed by the screw feeding portion 9.

The screw driving machine 1A includes a main chamber 13 to which compressed air is supplied from an external air compressor (not illustrated). The main chamber 13 is provided in the handle 11 and on an outer periphery of the driving cylinder 30 connected to an inside of the handle 11 in the body 10. Compressed air decompressed by a pressure reducing valve 13a is supplied to the main chamber 13. In addition, the screw driving machine 1A includes an exhaust pipe 14. The compressed air supplied to the driving cylinder 30, the air motor 31, and the like, is discharged from the exhaust pipe 14. The exhaust pipe 14 is provided in the handle 11. The compressed air is discharged from the exhaust pipe 14 via an exhaust filter 14a.

The screw driving machine 1A includes a timer chamber 32 and a blowback chamber 33. The timer chamber 32 is supplied with the compressed air for causing the controller 70 to operate. The blowback chamber 33 causes the driving piston 30a moved to the bottom dead center position to return to the top dead center position and is supplied with the compressed air for causing the screw feeding portion 9 to operate.

The timer chamber 32 and the blowback chamber 33 are provided on an outer peripheral side of the driving cylinder 30 inside the body 10. The timer chamber 32 is in communication with a space in the driving cylinder 30 via a side hole flow path 32a provided on a side surface of the driving cylinder 30. The side hole flow path 32a is provided below the vicinity of the center between a lower end and an upper end of the driving cylinder 30.

The timer chamber 32 is connected to the first chamber 30c formed on the lower side of the driving piston 30a via the side hole flow path 32a until the driving piston 30a moves from the top dead center position to the position where the first seal portion 30b1 passes through the side hole flow path 32a, and the communication between the timer chamber 32 and the second chamber 30d formed on an upper side of the driving piston 30a is blocked by the second seal portion 30b2. In the timer chamber 32, when the driving piston 30a moves until the side hole flow path 32a is located between the first seal portion 30b1 and the second seal portion 30b2, the first chamber 30c and the side hole flow path 32a are blocked by the first seal portion 30b1, and the communication between the second chamber 30d and the side hole flow path 32a is blocked by the second seal portion 30b2. Further, when the driving piston 30a moves to the bottom dead center position, the timer chamber 32 is connected to the second chamber 30d via the side hole flow path 32a.

In addition, the blowback chamber 33 is in communication with the space in the driving cylinder 30 via side hole flow paths 33a and 33b provided on a side surface of the driving cylinder 30. The side hole flow path 33a is provided in the vicinity of the lower end of the driving cylinder 30 above the bumper 30e. The side hole flow path 33b is provided above the vicinity of the center between the lower end and the upper end of the driving cylinder 30.

The blowback chamber 33 is connected to the first chamber 30c via the side hole flow path 33a. When the blowback chamber 33 moves in the downward direction from the top dead center position to a position where the driving piston 30a passes through the side hole flow path 33b, the blowback chamber 33 is connected to the second chamber 30d via the side hole flow path 33b.

The main valve 5 is vertically movably provided on the outer peripheral side of the driving cylinder 30. In the screw driving machine 1A, a main valve upper chamber 52 is provided on an upper side of the main valve 5, and the main valve upper chamber 52 is connected to the start valve 6.

In the screw driving machine 1A, a main valve lower chamber 53 is provided on a lower side of the main valve 5, and the main valve lower chamber 53 is connected to the main chamber 13. Further, in the screw driving machine 1A, an air flow path 54 is provided between the driving cylinder 30 and the main valve 5. In the screw driving machine 1A, a supply port 34 is provided in a side surface on an upper end side of the driving cylinder 30. In the screw driving machine 1A, the air flow path 54 is connected to the driving cylinder 30 via the supply port 34. In the screw driving machine 1A, an air flow path 74 is provided between the air flow path 54 and the air motor 31, and the air flow path 54 is connected to the air motor 31 via the air flow path 74.

In the screw driving machine 1A, when the main valve 5 moves in the downward direction, the communication between the air flow path 54 and the main valve lower chamber 53 is blocked by the main valve 5. In the screw driving machine 1A, when the main valve 5 moves to a position where the communication between the air flow path 54 and the main valve lower chamber 53 is blocked, the air flow path 54 is connected to the exhaust pipe 14. In the screw driving machine 1A, when the main valve 5 moves in the upward direction, the air flow path 54 is connected to the main valve lower chamber 53 via the main valve 5.

In addition, the main valve 5 is biased by a main valve spring 51 in the downward direction, which is a direction in which the air flow path 54 is closed. The main valve spring 51 is provided in the main valve upper chamber 52.

In addition, in the main valve 5, the compressed air is supplied from the main chamber 13 to the main valve upper chamber 52 via the start valve 6, and the main valve 5 is pressed in the downward direction by the air pressure of the compressed air. In addition, in the main valve 5, the compressed air is supplied from the main chamber 13 to the main valve lower chamber 53, and the main valve 5 is pressed in the upward direction by the air pressure of the compressed air. Accordingly, the main valve 5 opens and closes the air flow path 54 connecting the

main chamber 13, the driving cylinder 30, and the air motor 31. When the main valve 5 is not in operation, the main valve 5 is biased in the downward direction to be located at the bottom dead center position based on a relation, the relation being of a force of the main valve spring 51 and a balance between the air pressure of the compressed air supplied to the main valve upper chamber 52 and the air pressure of the compressed air supplied to the main valve lower chamber 53, thereby blocking the air flow path 54 between the main valve lower chamber 53 and the driving cylinder 30. On the other hand, when the main valve 5 is in operation, the main valve 5 is pressed in the upward direction by the air pressure of the compressed air supplied from the main chamber 13 to the main valve lower chamber 53 when the main valve upper chamber 52 communicates with the atmosphere via the start valve 6, thereby opening the air flow path 54 between the main valve lower chamber 53 and the driving cylinder 30.

The start valve 6 includes a pilot valve 61 that opens and closes the main valve upper chamber 52, a valve stem 62 that causes the pilot valve 61 to operate, and a valve stem spring 63 that biases the pilot valve 61 in the upward direction and biases the valve stem 62 in the downward direction.

In the start valve 6, the pilot valve 61 is pressed in the downward direction due to the air pressure of the compressed air supplied from the main chamber 13. In addition, in the start valve 6, the pilot valve 61 is pressed in the upward direction due to the air pressure of the compressed air supplied from the main chamber 13 to a valve lower chamber 64.

Accordingly, in the start valve 6, the pilot valve 61 is held at an upper position based on a relation between a balance of the air pressure of the compressed air and a force of the valve stem spring 63. In contrast, in the start valve 6, when the valve stem 62 moves in the upward direction, the valve lower chamber 64 communicates with the atmosphere, and thus the pilot valve 61 moves in the downward direction due to the air pressure of the compressed air. Further, when the pilot valve 61 moves in the downward direction, a passage through which the main valve upper chamber 52 communicates with the atmosphere is opened.

The trigger 60 is provided on the lower side of the handle 11 and rotates about 60c as a fulcrum in response to an operation of an operator. The trigger 60 is biased in the direction separating from the valve stem 62 of the start valve 6 by a trigger spring 60d.

The trigger 60 includes a contact lever 60a that causes the valve stem 62 of the start valve 6 to operate. The contact lever 60a is supported by the trigger 60 so as to be rotatable about a shaft 60b as a fulcrum.

In the start valve 6, in accordance with an operation of pressing the contact arm 8 against the driven member 300, the contact lever 60a comes into contact with the valve stem 62 and the valve stem 62 moves in the upward direction by a combination of an operation of moving the contact arm 8 in the upward direction relative to the body 10 and an operation of pulling the trigger 60. The start valve 6 operates when the valve stem 62 moves in the upward direction.

On the other hand, in the start valve 6, in accordance with an operation of pressing the contact arm 8 against the driven member 300, the contact lever 60a does not come into contact with the valve stem 62 only by an operation of moving the contact arm 8 in the upward direction relative to the body 10 or only by an operation of pulling the trigger 60.

Accordingly, the start valve 6 is operated by a combination of an operation of the trigger 60 and an operation of pressing the contact arm 8. An order of the operation of the trigger 60 and the operation of pressing the contact arm 8 is optional.

The on-off valve 7 is vertically movably supported by an on-off valve cylinder 73 provided on a side portion of the body 10. In the on-off valve cylinder 73, an on-off valve lower chamber 73a is provided on a lower side of the on-off valve 7, and an on-off valve upper chamber 73b is provided on an upper side of the on-off valve 7. When compressed air is supplied to the on-off valve upper chamber 73b, the on-off valve 7 moves in the downward direction by the pressure of the compressed air. When no compressed air is supplied to the on-off valve upper chamber 73b, the on-off valve 7 moves in the upward direction by the pressure of the compressed air supplied to the on-off valve lower chamber 73a.

The on-off valve 7 closes the air flow path 74 by moving in the downward direction, and blocks the flow of air between the main chamber 13 and the air motor 31. When the on-off valve 7 moves in the upward direction, the on-off valve 7 opens the air flow path 74 to establish communication between the main chamber 13 and the air motor 31.

The controller 70 includes a control valve cylinder 75 and a first control valve 72 accommodated in the control valve cylinder 75. The first control valve 72 is supported by the control valve cylinder 75 to be vertically movable, and partitions the inside of the control valve cylinder 75 into a third chamber 75a and a fourth chamber 75b. The controller 70 also includes a communication passage 75c that allows the third chamber 75a to communicate with the timer chamber 32. The communication passage 75c allows the driving cylinder 30 to communicate with the third chamber 75a via the timer chamber 32. The controller 70 further includes a second control valve 71 provided above the first control valve 72.

The controller 70 includes a first biasing member 72b that biases the first control valve 72 in the downward direction and a second biasing member 71a that biases the second control valve 71 in the downward direction.

The third chamber 75a of the control valve cylinder 75 is in communication with the space in the driving cylinder 30 via the timer chamber 32. In addition, in the control valve cylinder 75, the third chamber 75a is in communication with an outside of a body of the screw driving machine 1A via an exhaust passage 75d.

The first control valve 72 moves in the downward direction by being biased in the downward direction by the first biasing member 72b. The first control valve 72 moves to the bottom dead center position by moving in the downward direction. When the first control valve 72 moves in the upward direction from the bottom dead center position, the first control valve 72 moves to the top dead center position through a pressure control start position.

The first control valve 72 includes a seal portion 72c that opens and closes the exhaust passage 75d. While the first control valve 72 is on standby at a standby position P100, the seal portion 72c moves to a position where the exhaust passage 75d is opened. When the seal portion 72c moves to the position where the exhaust passage 75d is opened, the third chamber 75a of the control valve cylinder 75 is in communication with the outside of the body of the screw driving machine 1A via the exhaust passage 75d.

The second control valve 71 is configured by a rod-shaped member extending in the up-down direction, and is vertically movably supported with respect to the on-off valve 7. The second control valve 71 moves to a standby position P110 by being biased in the arrow D direction by the second biasing member 71a. In addition, the second control valve 71 is operated by being pressed by the first control valve 72. The second control valve 71 moves from the standby position P110 to an operation completion position and is configured to cause the on-off valve 7 to operate by switching whether the compressed air is to be supplied to the on-off valve upper chamber 73b of the on-off valve cylinder 73.

The screw feeding portion 9 includes a feeding member 91 that feeds the screw 200 and a feed piston 92 that causes the feeding member 91 to operate. The feeding member 91 is movably supported in a direction approaching and a direction away from the nose 12 and is configured to feed the screw 200 coupled by the coupling band 201 to the injection passage 12a of the nose 12 by locking with a claw portion (not illustrated).

The feed piston 92 is coupled to the feeding member 91 and is provided in a feed cylinder 93 to be slidable. The feed cylinder 93 is connected to the blowback chamber 33 via a feed flow path 94, and is supplied with compressed air from the blowback chamber 33.

The feed piston 92 is operated by the air pressure of the compressed air supplied from the blowback chamber 33 to cause the feeding member 91 to move in the direction away from the nose 12. In addition, when the feeding member 91 is biased by the biasing member 95 such as a coil spring toward the arrow R and the air pressure in the feed cylinder 93 on an arrow R side of the feed piston 92 decreases, the feed piston 92 causes the feeding member 91 to move in the direction approaching the nose 12 by biasing of the biasing member 95.

The magazine 90 is provided on the lower side of the handle 11 and is coupled to the nose 12. In the magazine 90, a plurality of screws 200 are coupled by the coupling band 201, and a screw coupling body in a form of, for example, a spiral shape is accommodated.

The contact arm 8 is an example of a contact. The contact arm 8 includes the lower arm 80 that comes into contact with the driven member 300 and the upper arm 81 that presses the contact lever 60a of the trigger 60. In addition, the contact arm 8 includes a transmission member 82 that transmits movement of the lower arm 80 to the upper arm 81.

FIGS. 2E and 2F are sectional views illustrating an example of the transmission member. The transmission member 82 includes a first roller 82a, a second roller 82b, a third roller 82c, and a shaft 82d. The first roller 82a, the second roller 82b, and the third roller 82c are provided coaxially with respect to the shaft 82d, and are arranged in parallel along an extending direction of the shaft 82d. The first roller 82a, the second roller 82b, and the third roller 82c are supported by the shaft 82d to be independently rotatable.

The third roller 82a includes an enlarged diameter portion 82a1 at an opposite end of the second roller 82b. The enlarged diameter portion 82a1 has a circular shape having a diameter larger than that of the first roller 82a. The third roller 82c includes an enlarged diameter portion 82c1 at an opposite end of the second roller 82b. The enlarged diameter portion 82c1 has a circular shape having a diameter larger than that of the third roller 82c.

The shaft 82d includes a contacted portion 82e on a third roller 82c side. The contacted portion 82e is formed in a circular shape having a diameter larger than a diameter of the shaft 82d. When the shaft 82d is inserted into the third roller 82c, the contacted portion 82e protrudes outward in the axial direction of the shaft 82d with respect to an end of the third roller 82c. A retaining member (not illustrated) is detachably attached to an end of the shaft 82d on a first roller 82a side.

Accordingly, the first roller 82a, the second roller 82b, and the third roller 82c are prevented from being disengaged from the shaft 82d by the contacted portion 82e and the retaining member (not illustrated). The first roller 82a, the second roller 82b, and the third roller 82c of the transmission member 82 are integrally movable in a direction intersecting the axial direction of the shaft 82d.

The lower arm 80 and the upper arm 81 are movable in the downward direction and the upward direction relative to the body 10. The lower arm 80 moves in the downward direction and the upward direction to move the transmission member 82. A direction in which the transmission member 82 moves is guided by a switching member 46 to be described later. The lower arm 80 and the upper arm 81 are switched between a state where the lower arm 80 and the upper arm 81 move in the up-down direction in conjunction with each other and a state where the conjunction is released and the lower arm 80 moves in the up-down direction independently of the upper arm 81 in accordance with a direction in which the transmission member 82 moves.

The lower arm 80 is an example of a first arm, is movably supported by the nose 12 of the screw driving machine 1A in the up-down direction, and is biased in the downward direction by a biasing member 83a formed of a coil spring or the like.

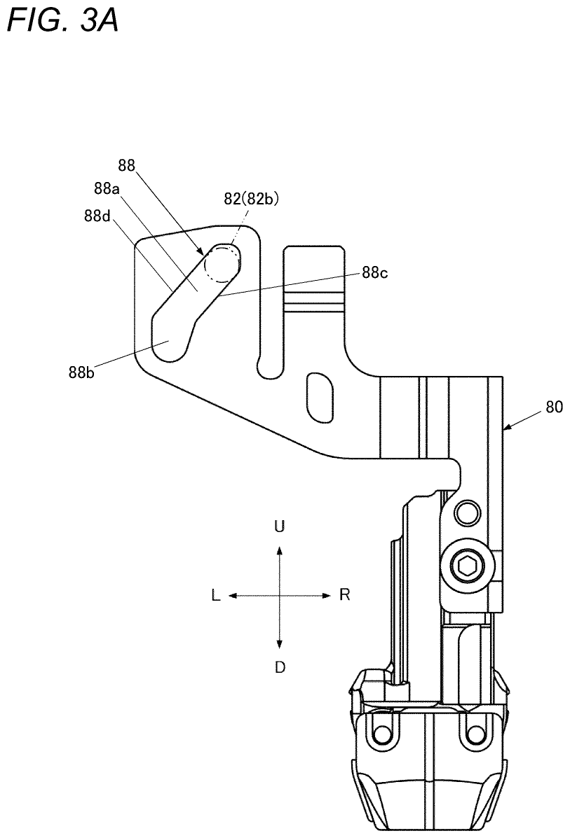

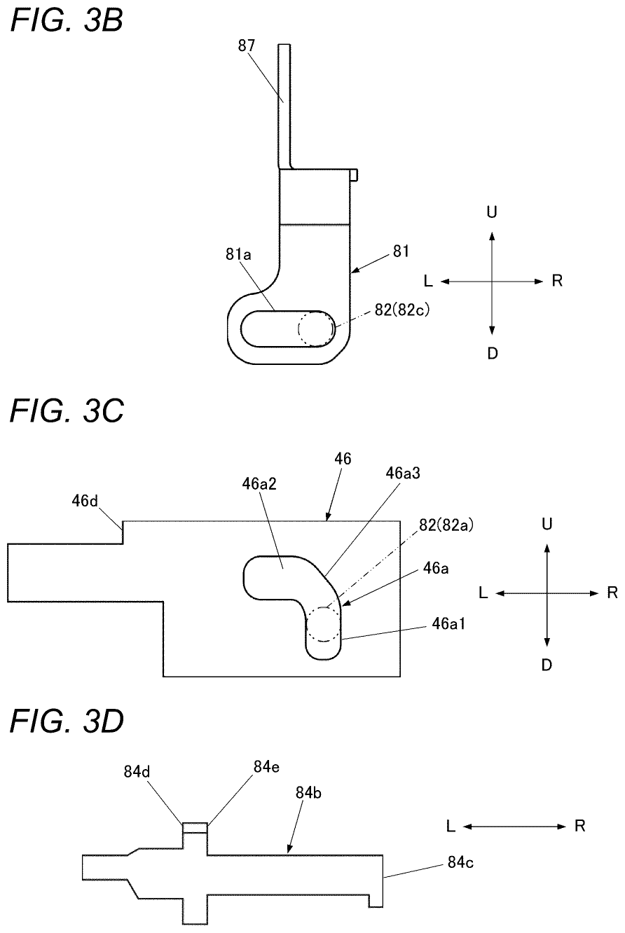

FIG. 3A is a side view illustrating an example of the lower arm. The lower arm 80 includes a cam groove 88 for moving the transmission member 82.

The cam groove 88 includes a first cam groove 88a that extends in an oblique direction with respect to the arrow U and D directions (up-down direction), and a second cam groove 88b that extends along the arrow U and D directions. Here, the arrow U and D directions may be referred to as a direction parallel to a first direction. In other words, the up direction of the first direction corresponds to the arrow U direction, and the down direction of the first direction corresponds to the arrow D direction.

The directions intersecting the arrow U and D directions are indicated by arrows L and R. Here, the arrow L and R directions may be referred to as a direction parallel to a second direction. In other words, the left direction of the second direction corresponds to the arrow L direction, and the right direction of the second direction corresponds to the arrow R direction. The arrow L and the arrow R are also directions toward and away from the injection passage 12a of the nose 12, the arrow R is a direction toward the injection passage 12a, and the arrow Lis a direction away from the injection passage 12a. The first cam groove 88a is inclined at a predetermined angle in a direction in which the upper side faces the arrow R side and the lower side faces the arrow L side.

The first cam groove 88a includes a first engagement portion 88c formed by a lower side of a pair of opposing sides inclined in the same direction, and a second engagement portion 88d formed of an upper side.

In the first cam groove 88a, the first engagement portion 88c and the second engagement portion 88d face each other at a predetermined interval at which the second roller 82b can enter between the first engagement portion 88c and the second engagement portion 88d. The second roller 82b is movable between the first engagement portion 88c and the second engagement portion 88d along a direction in which the first engagement portion 88c and the second engagement portion 88d extend. The first engagement portion 88c and the second engagement portion 88d may be formed of straight lines or curved lines.

The upper arm 81 is an example of a second arm, is movably supported by a side portion of the body 10 of the screw driving machine 1A in the up-down direction, and is biased in the downward direction by a biasing member 83b formed of a coil spring or the like.

FIG. 3B is a side view illustrating an example of the upper arm. The upper arm 81 includes a guide groove 81a to which the movement of the lower arm 80 is transmitted via the transmission member 82, and a pressing member 87 that presses the contact lever 60a.

The guide groove 81a has an elongated hole shape extending along the arrow L and R directions. The guide groove 81a is configured such that an interval between two sides facing each other in a short direction is slightly longer than a diameter of the third roller 82c. Accordingly, the third roller 82c can enter the guide groove 81a, and the guide groove 81a guides the movement of the third roller 82c along the arrow L and R directions. The pressing member 87 has a portion protruding in the upward direction. The pressing member 87 may be formed integrally with the upper arm 81 or may be formed as a separate component.

The screw driving machine 1A includes the switching member 46 that switches whether the lower arm 80 moves in conjunction with the upper arm 81.

FIG. 3C is a side view illustrating an example of the switching member. The switching member 46 is an example of a guide portion and includes a guide groove 46a that guides the transmission member 82 to move to a predetermined position. The switching member 46 switches whether the lower arm 80 moves in conjunction with the upper arm 81 in accordance with a position of the transmission member 82 guided by the guide groove 46a.

The guide groove 46a includes a first guide groove 46a1 that extends along the up-down direction. The first guide groove 46a1 is configured such that an interval between two sides facing each other in the short direction is slightly longer than a diameter of the first roller 82a. Accordingly, the first guide groove 46a1 guides the first roller 82a along a moving direction of the lower arm 80 in a state where the first roller 82a can enter and movement of the first roller 82a in the arrow L and R directions is restricted.

The guide groove 46a includes a second guide groove 46a2 extending along the arrow L and R directions. The second guide groove 46a2 is configured such that an interval between two sides facing each other in the short direction is slightly longer than the diameter of the first roller 82a. Accordingly, the second guide groove 46a2 guides the first roller 82a along the arrow L and R directions intersecting the moving direction of the lower arm 80 in a state where the first roller 82a can enter and the movement of the first roller 82a along the moving direction of the lower arm 80 is restricted.

The guide groove 46a includes a third guide groove 46a3 that guides the first roller 82a between the first guide groove 46a1 and the second guide groove 46a2. In the third guide groove 46a3, an inner side of a portion bent from the first guide groove 46a1 to the second guide groove 46a2 is formed by a curved surface, and an outer side is formed by a curved surface and an inclined surface.

In the screw driving machine 1A, the cam groove 88 of the lower arm 80, the guide groove 81a of the upper arm 81, and the guide groove 46a of the switching member 46 overlap each other.

In the transmission member 82, the first roller 82a, the second roller 82b, and the third roller 82c are inserted into a space in a portion where the cam groove 88, the guide groove 81a, and the guide groove 46a intersect. Accordingly, each roller of the transmission member 82 is movably supported along each groove. In addition, each roller of the transmission member 82 is rotatable independently of each groove.

The screw driving machine 1A includes a biasing member 84a that causes the transmission member 82 to move along the second guide groove 46a2 of the guide groove 46a, and a biasing force transmission member 84b that transmits, to the third roller 82c, a force for the biasing member 84a to move the transmission member 82.

The biasing member 84a is formed of a coil spring or the like, and expands and contracts along the arrow L and R directions. The switching member 46 includes an extension regulating portion 46e with which the biasing member 84a comes into contact. The biasing member 84a is regulated from extending in the arrow L direction beyond the extension regulating portion 46e by an end on an arrow L side coming into contact with the extension regulating portion 46e.

FIG. 3D is a side view illustrating an example of the biasing force transmission member. The biasing force transmission member 84b is an example of a biasing force switching portion, and includes a pressing portion 84c that presses the third roller 82c via the contacted portion 82e, a pressed portion 84d that is pressed by the biasing member 84a, and a position regulating portion 84e that regulates a position of the biasing force transmission member 84b. The biasing force transmission member 84b is supported by the switching member 46 to be movable along the arrow L and R directions. The switching member 46 includes a regulating portion 46d with which the position regulating portion 84e comes into contact. The regulating portion 46d is an example of a biasing force switching portion, and regulates the biasing force transmission member 84b from moving in the arrow R direction when the position regulating portion 84e comes into contact with the regulating portion 46d.

The biasing member 84a is inserted between the extension regulating portion 46e and the pressed portion 84d. When the compressed biasing member 84a extends in the arrow R direction, the pressed portion 84d of the biasing force transmission member 84b is pressed by the biasing member 84a and moves in the arrow R direction. Accordingly, the pressing portion 84c approaches the first guide groove 46a1 of the guide groove 46a. When the pressed portion 84d is pressed by the biasing member 84a and the position regulating portion 84e moves to a position in contact with the regulating portion 46d, a movement amount of the biasing force transmission member 84b in the arrow R direction is regulated.

In the biasing force transmission member 84b, at a position where the position regulating portion 84e is in contact with the regulating portion 46d, the pressing portion 84c is away from the contacted portion 82e with respect to the transmission member 82 in which the first roller 82a is guided by the first guide groove 46a1. Accordingly, the transmission of the biasing force of the biasing member 84a against the transmission member 82 guided by the first guide groove 46a1 via the first roller 82a is released. Accordingly, at a position where the first roller 82a is guided by the first guide groove 46a1, the transmission member 82 is prevented from being pressed in the arrow R direction by the biasing member 84a.

Therefore, the transmission member 82 is prevented from being pressed toward the arrow R side of the first guide groove 46a1 by the biasing member 84a via the first roller 82a, and the sliding resistance when the first roller 82a comes into contact with the first guide groove 46a1 and moves is reduced. The biasing force of the biasing member 84a against the first roller 82a guided in the second guide groove 46a2 is required to move the transmission member 82 in conjunction with the movement of the lower arm 80 in the downward direction. This biasing force is unnecessary while the first roller 82a is guided in the first guide groove 46a1. Therefore, the biasing force of the biasing member 84a against the first roller 82a guided in the first guide groove 46a1 may be weaker than the biasing force of the biasing member 84a against the first roller 82a guided in the second guide groove 46a2. Therefore, the pressing portion 84c may be in contact with the contacted portion 82e as long as the first roller 82a is prevented from being pressed by the biasing member 84a in the arrow R direction at a position where the first roller 82a is guided by the first guide groove 46a1.

At the position where the first roller 82a is guided by the second guide groove 46a2, the pressing portion 84c of the biasing force transmission member 84b comes into contact with the contacted portion 82e, and the pressing portion 84c is pressed in the arrow L direction away from the first guide groove 46a1, so that the biasing member 84a is compressed in the arrow L direction.

Accordingly, at the position where the first roller 82a is guided by the second guide groove 46a2, the biasing force transmission member 84b presses the transmission member 82 in the arrow R direction by the biasing member 84a via the first roller 82a. Accordingly, the transmission member 82 is biased by the biasing member 84a in a direction in which the first roller 82a moves from the second guide groove 46a2 to the first guide groove 46a1.

In the screw driving machine 1A, the lower arm 80 moves in the upward direction from the bottom dead center position due to the relative movement with respect to the body 10 by the operation of pressing the contact arm 8 against the driven member 300. In a predetermined range in which the lower arm 80 moves in the upward direction from the bottom dead center position, the first roller 82a of the transmission member 82 is guided by the first guide groove 46a1. In the screw driving machine 1A, at the position of the transmission member 82 where the first roller 82a is guided by the first guide groove 46a1, the upper arm 81 moves in the upward direction in conjunction with the lower arm 80. In the screw driving machine 1A, when the lower arm 80 moves in the upward direction from the bottom dead center position, the body 10 and the driven member 300 relatively approach each other.

When the lower arm 80 and the upper arm 81 move to a sign-in position where the start valve 6 is operable, the first roller 82a of the transmission member 82 is guided by the second guide groove 46a2. At the position of the transmission member 82 where the first roller 82a is guided by the second guide groove 46a2, the engagement between the lower arm 80 and the upper arm 81 is released. Accordingly, the lower arm 80 moves independently of the upper arm 81.

When the main valve 5 is operated and the screw 200 is driven into the driven member 300, the head portion of the screw 200 is lifted from the driven member 300, so that the driving depth regulating portion 4a regulates, between the sign-in position and the top dead center position, a movement amount of the lower arm 80 from the bottom dead center position.

Therefore, the driving depth regulating portion 4a includes a locking member 40 that regulates the movement amount of the lower arm 80 from a first bottom dead center position P1. The locking member 40 is supported by the feeding member 91 of the screw feeding portion 9. In the locking member 40, a locking portion 40b with which the lower arm 80 comes into contact is formed on an end on the arrow R side.

The locking member 40 moves, by the movement of the feeding member 91, between the locking position where the locking portion 40b protrudes to a movement path of the lower arm 80 and a second retracted position to which the locking portion 40b is retracted from the movement path of the lower arm 80.

The screw driving machine 1A includes a tightening depth adjusting portion 86 that adjusts a tightening depth of the screw 200. The tightening depth adjusting portion 86 defines a top dead center position of the contact arm 8. The tightening depth adjusting portion 86 is pressed by the contact arm 8 to cause the first control valve 72 to operate.

The tightening depth adjusting portion 86 is supported to be movable in the up-down direction. The tightening depth adjusting portion 86 is biased in the downward direction by a biasing member 86c such as a coil spring. The tightening depth adjusting portion 86 is configured such that the entire length along the up-down direction can be adjusted by operating a dial portion 86d.

The tightening depth adjusting portion 86 is separated from the lower arm 80 when the lower arm 80 is at the bottom dead center position. When the lower arm 80 moves in the upward direction from the bottom dead center position, the lower arm 80 comes into contact with tightening depth adjusting portion 86.

In a state before the tightening depth adjusting portion 86 is pressed by the lower arm 80 and moved, the tightening depth adjusting portion 86 and the first control valve 72 are separated from each other. When the lower arm 80 moves in the upward direction from the bottom dead center position, the lower arm 80 comes into contact with tightening depth adjusting portion 86. When the tightening depth adjusting portion 86 is pressed by the lower arm 80 and moves in the upward direction, the tightening depth adjusting portion 86 comes into contact with the first control valve 72.

When the tightening depth adjusting portion 86 is pressed up by the lower arm 80 moving in the upward direction and moves to a position in contact with a movement regulating portion 86e, the tightening depth adjusting portion 86 regulates the lower arm 80 from further moving in the upward direction.

Accordingly, the position of the lower arm 80 regulated by the movement of the tightening depth adjusting portion 86 to the position in contact with the movement regulating portion 86e becomes the top dead center position of the lower arm 80.

As the overall length of the tightening depth adjusting portion 86 changes, a position where the lower arm 80 comes into contact moves in the up-down direction. Accordingly, the top dead center position of the lower arm 80 moves. When the top dead center position of the lower arm 80 moves, a distance between the body 10 and the driven member 300 changes at a timing when the rotation of the air motor 31 stops, and a tightening depth of the screw 200 with respect to the driven member 300 changes.

In the screw driving machine 1A, the tightening depth adjusting portion 86 may not be provided, the lower arm 80 may be in directly contact with the first control valve 72 to cause the first control valve 72 to operate, and the upper fulcrum position of the lower arm 80 may be defined.

### Operation Example of Screw Driving Machine according to Present Embodiment

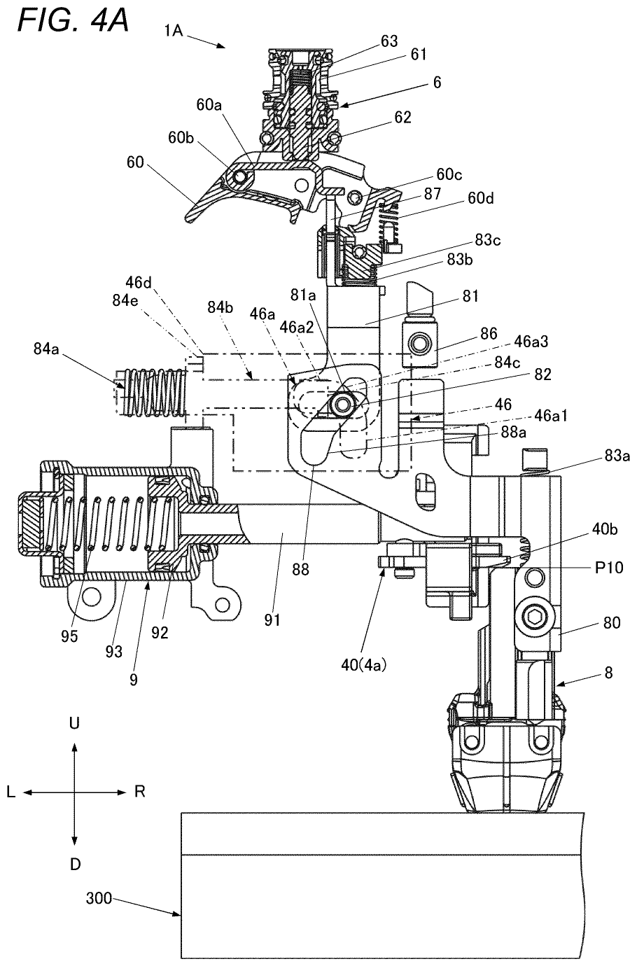

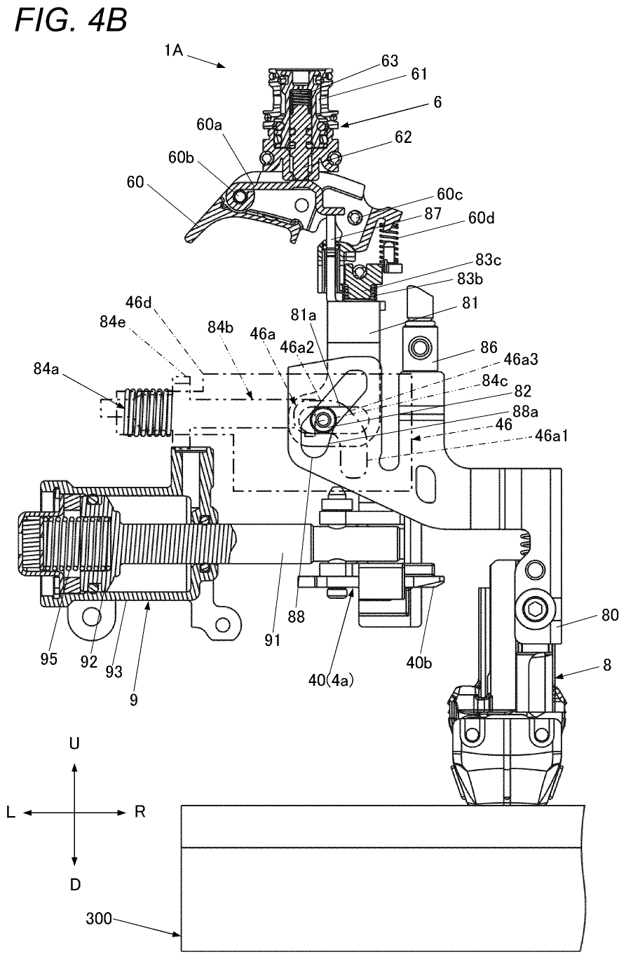

FIGS. 4A and 4B are side sectional views of main parts of the screw driving machine according to the present embodiment illustrating an example of the operation of driving a screw into a driven member and tightening the screw. Next, an example of an operation of the screw driving machine 1A that performs driving and tightening of the screw 200 will be described.

The operator holds the handle 11 of the screw driving machine 1A and presses the contact arm 8 against the driven member 300. In the screw driving machine 1A, when the contact arm 8 is pressed against the driven member 300, the lower arm 80 moves in the upward direction indicated by the arrow U with respect to the body 10 due to the relative movement between the contact arm 8 and the body 10.

When the lower arm 80 moves in the upward direction, the first engagement portion 88c of the first cam groove 88a of the cam groove 88 inclined with respect to the moving direction of the lower arm 80 presses the second roller 82b.

In the transmission member 82, when the second roller 82b receives a pressing force from the first engagement portion 88c of the first cam groove 88a of the cam groove 88, the first roller 82a is guided by the first guide groove 46a1 and moves in the upward direction.

In the transmission member 82, when the first roller 82a moves in the upward direction, the third roller 82c presses the guide groove 81a of the upper arm 81 upward. Accordingly, the upper arm 81 moves in the upward direction in conjunction with the lower arm 80.

A position of the upper arm 81 where the upper arm 81 can come into contact with the contact lever 60a and cause the contact lever 60a to operate is referred to as an operable position. When the lower arm 80 and the upper arm 81 move in the upward direction due to the relative movement with respect to the body 10 and the lower arm 80 moves to a driving depth defining position P10 in contact with the locking portion 40b of the locking member 40 as illustrated in FIG. 4A, the upper arm 81 moves to the operable position. Accordingly, in a state where the contact arm 8 is pressed against the driven member and the lower arm 80 moves to the driving depth defining position P10 and the operation of pulling the trigger 60 is performed, the contact lever 60a presses the valve stem 62 of the start valve 6, and the start valve 6 is brought into a sign-in state where the start valve 6 is operated.

By the operation of pressing the contact arm 8 against the driven member 300, the first roller 82a of the transmission member 82 is guided by the first guide groove 46a1 until the sign-in state is reached. At the position of the transmission member 82 where the first roller 82a is guided by the first guide groove 46a1, the position regulating portion 84e of the biasing force transmission member 84b is in contact with the regulating portion 46d, and the pressing portion 84c is separated from the contacted portion 82e.

When the lower arm 80 and the upper arm 81 move in the upward direction to a position where the sign-in can be performed, the transmission member 82 moves to a position where the first roller 82a is guided by the third guide groove 46a3. At the position of the transmission member 82 where the first roller 82a is guided by the third guide groove 46a3 of the guide groove 46a, the pressing portion 84c of the biasing force transmission member 84b is separated from the contacted portion 82e. Alternatively, at the position of the transmission member 82 where the first roller 82a is guided by the third guide groove 46a3, even if the pressing portion 84c of the biasing force transmission member 84b comes into contact with the contacted portion 82e, the biasing member 84a is prevented from being compressed.

Accordingly, by the operation of pressing the contact arm 8 against the driven member 300, the transmission member 82 is prevented from being pressed in the arrow R direction by the biasing member 84a until the sign-in state is reached. Accordingly, in the transmission member 82, the first roller 82a is prevented from being pressed by the biasing member 84a into the first guide groove 46a1 and the third guide groove 46a3, and the sliding resistance when the first roller 82a moves in contact with the first guide groove 46a1 and the third guide groove 46a3 is reduced. As a result, by the operation of pressing the contact arm 8 against the driven member 300, the lower arm 80 and the upper arm 81 move in the upward direction due to the relative movement with respect to the body 10, and the biasing force of the biasing member 84a is applied to the lower arm 80 and the upper arm 81 until the sign-in state is reached, and is prevented from being transmitted to the operator as a load.

When the start valve 6 is operated, the main valve 5 moves in the upward direction by the air pressure of the compressed air supplied from the main chamber 13 to the main valve lower chamber 53, and the main valve lower chamber 53 and the air flow path 54 are connected so that the compressed air can be supplied from the main chamber 13 to the air flow path 54.

Accordingly, in the driving cylinder 30, the compressed air is supplied from the main chamber 13 to the second chamber 30d via the air flow path 54. The driving piston 30a is pressed by an air pressure of the compressed air supplied to the second chamber 30d of the driving cylinder 30 and moves in a downward direction indicated by the arrow D from the top dead center position to cause the driver bit 2 to move in the downward direction along the axial direction. The driver bit 2 and the motor shaft 31a move integrally with the driving piston 30a. The driver bit 2 that moves in the downward direction is guided by the injection passage 12a of the nose 12, thereby driving the screw 200 supplied from the magazine 90 to the injection passage 12a into the driven member 300.

When the driving piston 30a moves in the downward direction from the top dead center position and the second seal portion 30b2 passes through the side hole flow path 33b of the driving cylinder 30, the compressed air is supplied from the second chamber 30d to the blowback chamber 33 via the side hole flow path 33b, and the pressure in the blowback chamber 33 increases. When the pressure in the blowback chamber 33 increases, the pressure in the feed cylinder 93 connected to the blowback chamber 33 via the feed flow path 94 increases, and the feed piston 92 is pressed in the arrow L direction by the air pressure. Accordingly, the feeding member 91 coupled to the feed piston 92 moves in the arrow L direction.

When the feeding member 91 moves in the arrow L direction, the locking member 40 attached to the feeding member 91 moves in the arrow L direction. Accordingly, as illustrated in FIG. 4B, the locking member 40 moves to a retracted position where the locking portion 40b is retracted from the movement path of the lower arm 80. When the locking member 40 moves to the retracted position, by the operation of pressing the contact arm 8 against the driven member 300, the lower arm 80 can move in the upward direction beyond the driving depth defining position P10 due to the relative movement with respect to the body 10.

When the main valve 5 is operated, compressed air is supplied from the main chamber 13 to the on-off valve lower chamber 73a of the on-off valve cylinder 73, which is a space on the lower side of the on-off valve 7, via the air flow path 54. When the compressed air is supplied to the on-off valve lower chamber 73a, the on-off valve 7 is operated by the air pressure to move in the upward direction, and the air flow path 54 and the air flow path 74 are connected with each other. Accordingly, the compressed air is supplied to the air motor 31.

When the compressed air is supplied to the air motor 31, the driver bit 2 rotates, and the screw 200 driven into the driven member 300 is tightened. In addition, by the operation of pressing the contact arm 8 against the driven member 300, the body 10 further moves in the downward direction following the tightening of the screw 200.

When the lower arm 80 moves in the upward direction beyond the driving depth defining position P10 due to the relative movement with respect to the body 10, the second roller 82b of the transmission member 82 is pressed by the first engagement portion 88c of the cam groove 88, so that the first roller 82a moves from the first guide groove 46a1 of the switching member 46 to the second guide groove 46a2.

When the second roller 82b is further pressed by the first engagement portion 88c, the first roller 82a is guided by the second guide groove 46a2, so that the transmission member 82 moves in a lateral direction indicated by the arrow L. When the upper arm 81 moves to the operable position, the upper arm 81 comes into contact with a support convex portion 83c to which the biasing member 83b is attached. The support convex portion 83 is fixed in position with respect to the body 10. Accordingly, even if the lower arm 80 moves in the upward direction due to the relative movement with respect to the body 10, the upward movement of the upper arm 81 is regulated. Accordingly, interlockable engagement between the lower arm 80 and the upper arm 81 via the transmission member 82 is released, and the position of the upper arm 81 is held at the operable position while the upper arm 81 moves to the operable position and the first roller 82a is located in the second guide groove 46a2.

At the position where the first roller 82a is guided by the second guide groove 46a2, the pressing portion 84c of the biasing force transmission member 84b comes into contact with the contacted portion 82e, and the pressing portion 84c is pressed in the arrow L direction away from the first guide groove 46a1, so that the biasing member 84a is compressed in the arrow L direction.

In the controller 70, in a state where the lower arm 80 moves to the bottom dead center position, since the lower arm 80 does not come into contact with the tightening depth adjusting portion 86, the tightening depth adjusting portion 86 does not come into contact with the first control valve 72. In a state where the tightening depth adjusting portion 86 is not in contact with the first control valve 72, the first control valve 72 is biased by the first biasing member 72b and moves to the standby position P100, and the second control valve 71 is biased by the second biasing member 71a and moves to the standby position P110.

When the body 10 further moves in the downward direction following the tightening of the screw 200, and the lower arm 80 moves relatively in the upward direction by the operation of pressing the contact arm 8 against the driven member 300, the lower arm 80 comes into contact with the tightening depth adjusting portion 86 and presses the tightening depth adjusting portion 86 in the upward direction.

When the tightening depth adjusting portion 86 is pressed up by the lower arm 80 moving in the upward direction and the tightening depth adjusting portion 86 moves to a position in contact with the movement regulating portion 86e, the lower arm 80 is regulated from further moving in the upward direction. When the tightening depth adjusting portion 86 moves to a position in contact with the movement regulating portion 86e and the lower arm 80 moves to the top dead center position, the lower arm 80 presses the first control valve 72 in the upward direction via the tightening depth adjusting portion 86, and the first control valve 72 moves from the standby position P100 to the pressure control start position.

In the control valve cylinder 75, the third chamber 75a is normally in communication with the space in the driving cylinder 30 via the communication passage 75c and the side hole flow path 32a of the driving cylinder 30. When the main valve 5 is operated, the driving piston 30a moves in the downward direction by a predetermined distance, and the second seal portion 30b2 passes through the side hole flow path 32a, the second chamber 30d in the driving cylinder 30 communicates with the third chamber 75a of the control valve cylinder 75. Accordingly, the compressed air is supplied from the second chamber 30d to the timer chamber 32. During a period in which the first control valve 72 moves to the pressure control start position from a state where the first control valve 72 stands by at the standby position P100, the seal portion 72c of the first control valve 72 is at a position where the exhaust passage 75d is opened, and the third chamber 75a of the control valve cylinder 75 is in communication with the outside of the body of the screw driving machine 1A via the exhaust passage 75d. Accordingly, even when the compressed air is supplied from the timer chamber 32 to the third chamber 75a of the control valve cylinder 75, the third chamber 75a is maintained at atmospheric pressure, and the first control valve 72 does not operate with the air pressure.

When the first control valve 72 moves to the pressure control start position, the seal portion 72c of the first control valve 72 closes the exhaust passage 75d. When the air flow path to an outside of a gas passing through the exhaust passage 75d is blocked, pressure in the control valve cylinder 75 increases due to the air pressure of the compressed air supplied from the timer chamber 32 to the third chamber 75a of the control valve cylinder 75. When the pressure in the control valve cylinder 75 increases, the first control valve 72 is operated due to the air pressure, and the first control valve 72 further moves in the upward direction.

When the first control valve 72 further moves in the upward direction from the pressure control start position due to the air pressure of the compressed air and the first control valve 72 moves to the second control valve operation start position, the first control valve 72 comes into contact with the second control valve 71, and the first control valve 72 presses the second control valve 71 in the upward direction. When the second control valve 71 moves to the operation completion position by movement of the first control valve 72 to the operation completion position, the compressed air is supplied to the on-off valve upper chamber 73b of the on-off valve cylinder 73 which is a space on the upper side of the on-off valve 7.

When the compressed air is supplied to the on-off valve upper chamber 73b, the on-off valve 7 moves in the downward direction due to a difference between pressure acting on the on-off valve 7 due to the compressed air supplied to the on-off valve upper chamber 73b and pressure acting on the on-off valve 7 due to the compressed air supplied to the on-off valve lower chamber 73a, and supply of the compressed air to the air motor 31 is stopped. When the supply of the compressed air to the air motor 31 is stopped, rotation of the driver bit 2 is stopped.

When the rotation of the driver bit 2 is stopped and the tightening of the screw 200 is completed, the operator weakens the force for pressing the contact arm 8 against the driven member 300 and moves the body 10 in a direction away from the driven member 300.

When the body 10 moves in the direction away from the driven member 300, the lower arm 80 moves in the arrow D direction from the top dead center position by the biasing of the biasing member 83a due to the relative movement of the body 10 and the lower arm 80.

While the lower arm 80 moves to the top dead center position, the transmission member 82 moves to a position where the first roller 82a is guided by the second guide groove 46a2. At the position where the first roller 82a is guided by the second guide groove 46a2, the pressing portion 84c of the biasing force transmission member 84b comes into contact with the contacted portion 82e, and the pressing portion 84c is pressed in the arrow L direction, so that the biasing member 84a is compressed in the arrow L direction.

Accordingly, when the lower arm 80 moves in the downward direction from the top dead center position, the second roller 82b is movable in the arrow R direction due to the inclination of the first engagement portion 88c and the second engagement portion 88d of the cam groove 88. The transmission member 82 moves in the arrow R direction with the first roller 82a being guided by the second guide groove 46a2 by the biasing force caused by the extension of the biasing member 84a.

Accordingly, by the operation of pressing the contact arm 8 against the driven member 300, it is possible to prevent the biasing force of the biasing member 84a from becoming a load until the sign-in state is reached. By the operation of moving the lower arm 80 in the downward direction from the top dead center position, the first roller 82a can reliably move from the second guide groove 46a2 of the guide groove 46a to the first guide groove 46a1, and the upper arm 81 can be reliably returned to the state of moving in conjunction with the movement of the lower arm 80.

When the first roller 82a moves from the second guide groove 46a2 to the first guide groove 46a1, the transmission member 82 is movable in the downward direction while been guided by the first guide groove 46a1. Accordingly, the upper arm 81 moves in the downward direction due to the relative movement with respect to the body 10 following the lower arm 80 by the biasing of the biasing member 83b.

When the upper arm 81 moves in the downward direction, the pressing of the contact lever 60a is released, and the contact lever 60a is away from the start valve 6. When the contact lever 60a is away from the start valve 6, the main valve 5 is closed, the second chamber 30d of the driving cylinder 30 communicates with the atmosphere via the air flow path 54 and the exhaust pipe 14, and the pressure in the second chamber 30d decreases.

When the pressure in the second chamber 30d of the driving cylinder 30 decreases to the atmospheric pressure, the driving piston 30a moves to the top dead center position by the air pressure in the blowback chamber 33. When the driving piston 30a moves to the top dead center position, the pressure in the blowback chamber 33 decreases, and the feeding member 91 coupled to the feed piston 92 moves in the arrow R direction by the biasing of the biasing member 94a.

When the feeding member 91 moves in the arrow R direction, a feeding claw (not illustrated) provided on the feeding member 91 feeds a next screw 200 to the injection passage 12a. In addition, the locking member 40 attached to the feeding member 91 moves in the arrow R direction. Accordingly, the locking member 40 moves to the locking position where the locking portion 40b protrudes to a movement path of a lower arm 80B.

Since the cam groove 88 includes the second cam groove 88b, a range in which the second roller 82b is movable relative to the cam groove 88 is secured when an upper fulcrum position of the lower arm 80 is adjusted by the tightening depth adjusting portion 86.

### Configuration Example of Screw Driving Machine according to Present Embodiment including Driving Depth Switching Portion of Screw

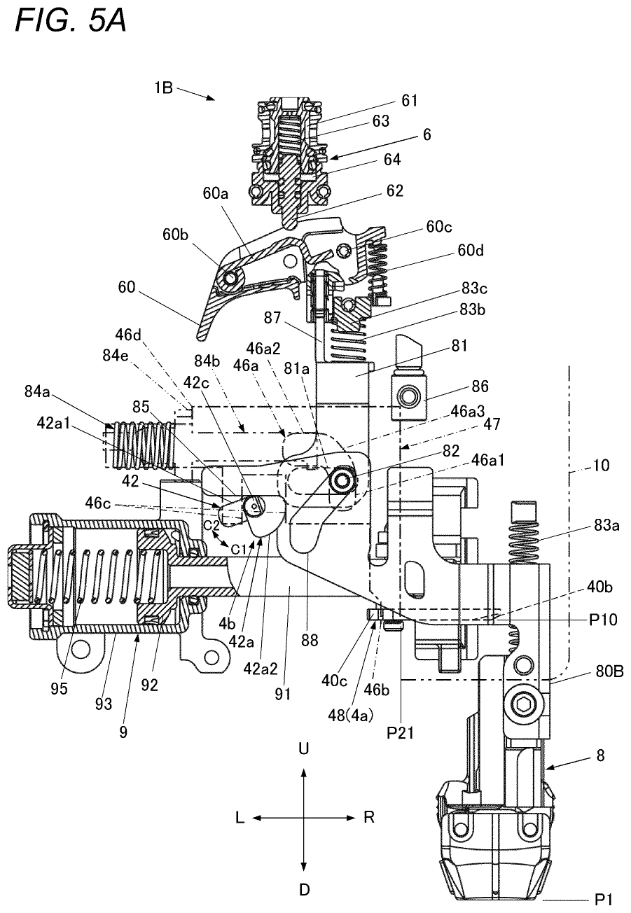

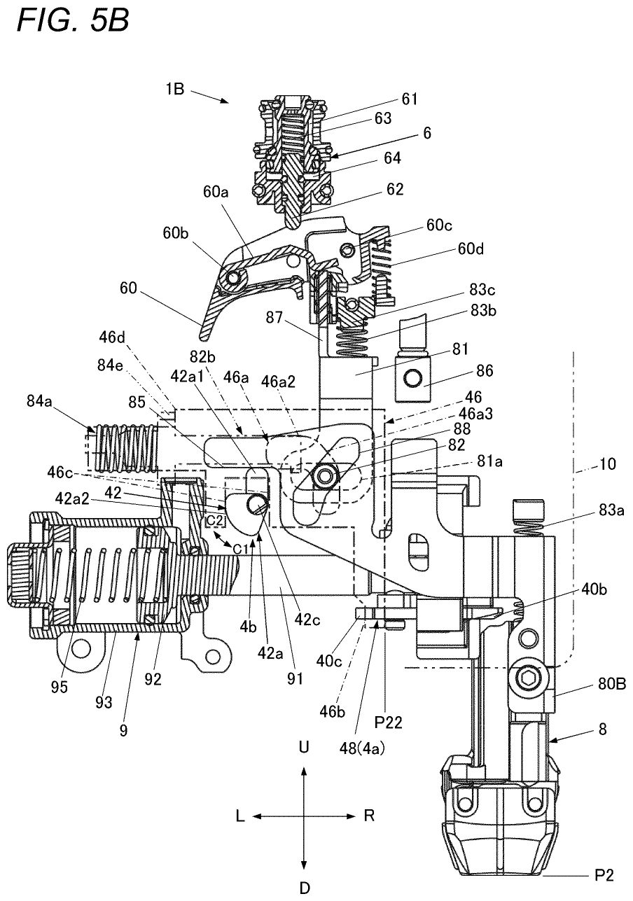

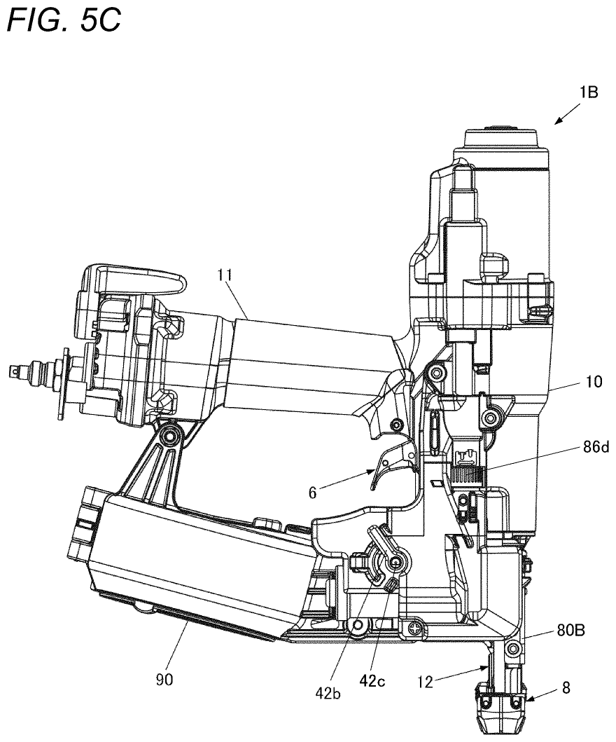

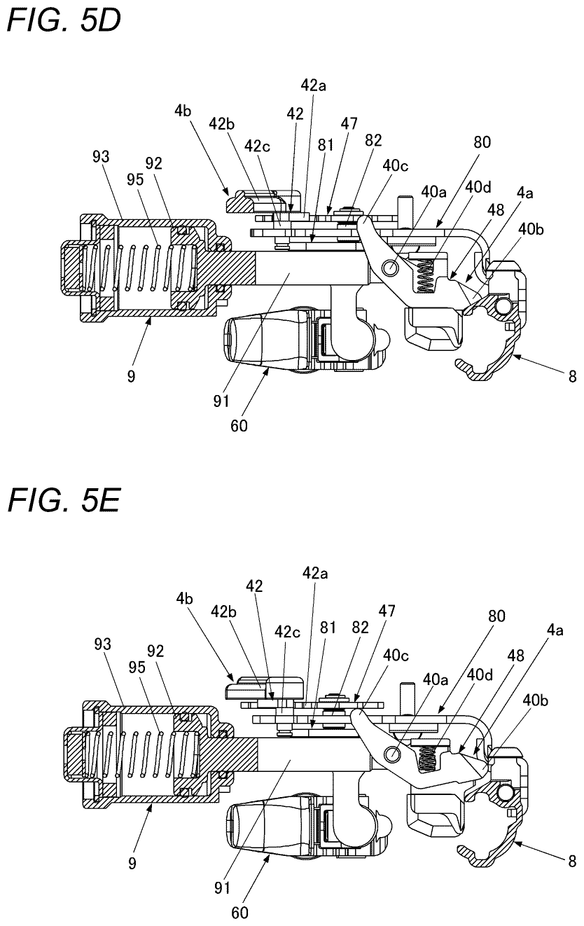

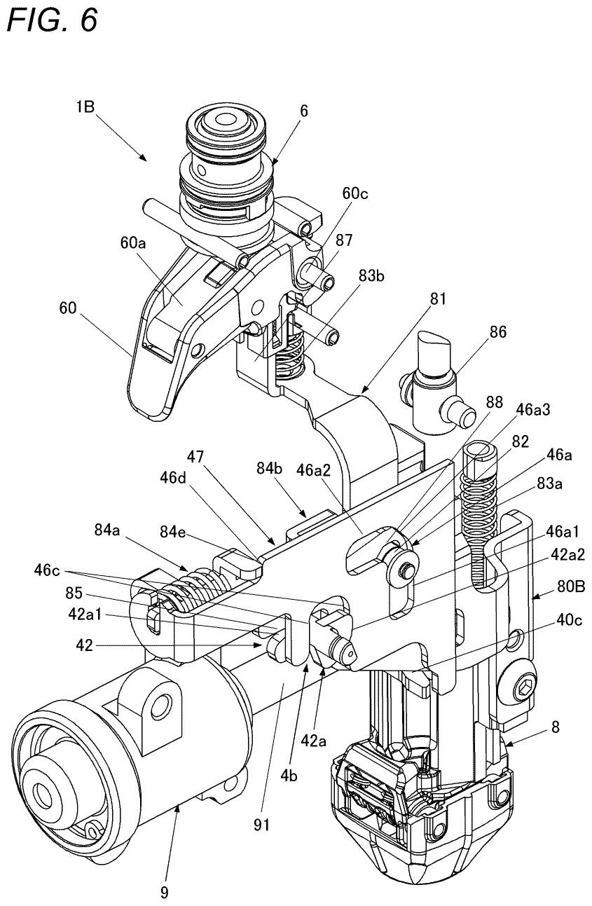

FIGS. 5A and 5B are side sectional views of main parts illustrating an example of a screw driving machine according to the present embodiment including a driving depth switching portion of a screw, FIG. 5C is a side view illustrating an example of the screw driving machine according to the present embodiment including the driving depth switching portion of the screw, FIG. 5D and FIG. 5E are bottom sectional views of main parts illustrating an example of the screw driving machine according to the present embodiment including the driving depth switching portion of the screw, and FIG. 6 is a perspective view of main parts illustrating an example of the screw driving machine according to the present embodiment including the driving depth switching portion of the screw.

FIGS. 5A, 5D, and 6 illustrate states of respective parts when a first mode in which a driving depth of the screw is set to a first driving depth is selected. In addition, FIGS. 5B and 5E illustrate states of respective parts when a second mode in which the driving depth of the screw is set to a second driving depth that is deeper than the first driving depth is selected. In a screw driving machine 1B including a driving depth switching portion of a screw, the same reference numerals are given to portions having the same configurations as those of the screw driving machine 1A including no driving depth switching portion.

The screw driving machine 1B includes a driving depth switching portion 4b that switches whether the driving depth of the screw 200 is regulated by the driving depth regulating portion 4a.

The driving depth regulating portion 4a includes a locking member 48 that regulates a movement amount of the lower arm 80B from the first bottom dead center position P1. In addition, the driving depth switching portion 4b includes a switching member 47 that switches whether a movement amount of the lower arm 80B is to be regulated by the locking member 48. The switching member 47 is an example of a guide portion, and also has a function of guiding a movement path of the transmission member 82 via the first roller 82a and switching whether the lower arm 80B moves in conjunction with the upper arm 81.

Further, the driving depth switching portion 4b includes a switching operation member 42 that causes the switching member 47 to operate and switches the bottom dead center position of the lower arm 80B to the first bottom dead center position P1 illustrated in FIG. 5A or a second bottom dead center position P2 illustrated in FIG. 5B.

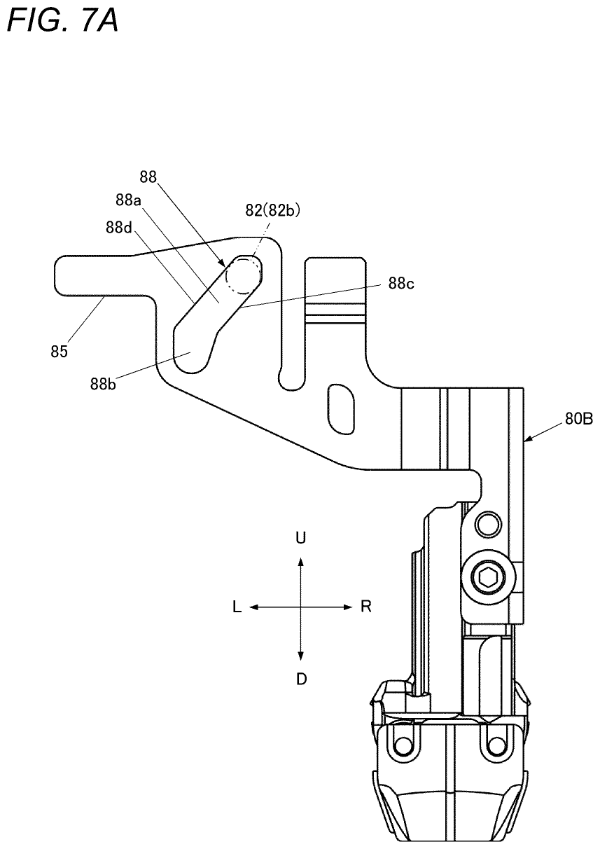

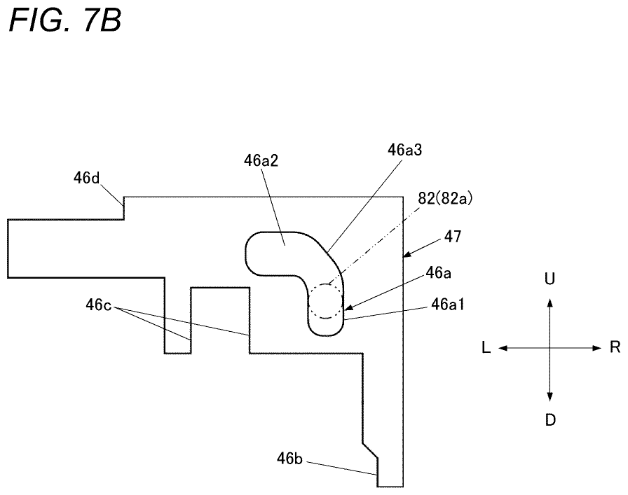

FIG. 7A is a side view illustrating an example of the lower arm of the screw driving machine including the driving depth switching portion. The lower arm 80B includes the above-described cam groove 88 that causes the transmission member 82 to move via the second roller 82b. The lower arm 80B includes a bottom dead center position switching affected portion 85 that receives a force for moving the lower arm 80B by the switching operation member 42 in the upward direction.

FIG. 7B is a side view illustrating an example of the switching member of the screw driving machine including the driving depth switching portion. The switching member 47 includes the above-described guide groove 46a that guides the first roller 82a to move the transmission member 82 to a predetermined position. In addition, the switching member 47 includes an actuation portion 46b that causes the locking member 48 to operate and switches whether the movement amount of the lower arm 80B is restricted by the locking member 48. Further, the switching member 47 includes an affected portion 46c that receives a force for causing the switching member 47 to move in the arrow L direction or the arrow R direction.

The switching operation member 42 includes an action portion 42a that moves the lower arm 80B and the switching member 47 in conjunction with each other, and an operation portion 42b that receives an operation of a person.

The action portion 42a includes a first cam surface 42a1 that is in contact with the bottom dead center position switching affected portion 85 of the lower arm 80B and causes the lower arm 80B to move in the upward direction. In addition, the action portion 42a includes a second cam surface 42a2 that is in contact with the affected portion 46c of the switching member 47 and causes the switching member 47 to move in the direction indicated by the arrow L or the arrow R.

The operation portion 42b is coupled to the shaft 42c and causes the action portion 42a to rotate with the shaft 42c as a fulcrum. When the operation portion 42b is operated to rotate the action portion 42a around the shaft 42c as a fulcrum, the first cam surface 42a1 of the switching operation member 42 is displaced to cause the lower arm 80B to move in the upward direction. When the second cam surface 42a2 is displaced, the switching member 47 moves in directions indicated by arrows L and R.

The locking member 48 is rotatably supported by the feeding member 91 of the screw feeding portion 9 with a shaft 40a as a fulcrum. In the locking member 48, the locking portion 40b to be locked to the lower arm 80B is formed on an end on the arrow R side with the shaft 40a interposed therebetween. An affected portion 40c with which the actuation portion 46b comes into contact is formed due to the movement of the switching member 47 on an end of the locking member 40 on the arrow L side with the shaft 40a interposed therebetween. The locking member 48 is biased by a biasing member 40d formed by a coil spring or the like in a direction in which the locking portion 40b protrudes to the movement path of the lower arm 80 by a rotating operation with the shaft 40a as a fulcrum.

The locking member 48 moves between a locking position where the locking portion 40b protrudes into the movement path of the lower arm 80B as illustrated in FIG. 5D and a first retracted position where the locking portion 40b is retracted from the movement path of the lower arm 80B by the movement of the switching member 47 without the movement of the feeding member 91 as illustrated in FIG. 5E, by rotation around the shaft 40a as a fulcrum. The locking member 48 moves between the above-described locking position and a second retracted position where the locking portion 40b is retracted from the movement path of the lower arm 80B by the movement of the feeding member 91 without the movement of the switching member 47. Further, the locking member 48 moves between the first retracted position and the second retracted position by the movement of the feeding member 91 in a state where the locking member 48 moves to the first retracted position by the movement of the switching member 47.

Accordingly, the driving depth switching portion 4b switches whether the movement amount of the lower arm 80B is restricted by moving the locking member 48 via the switching member 47. Further, the driving depth switching portion 4b moves the transmission member 82 via the switching member 47 in conjunction with the switching of whether the movement amount of the lower arm 80B is restricted by the movement of the switching member 47. Since the pressed portion 84d is in contact with the regulating portion 46d of the switching member 47, the biasing force transmission member 84b moves in conjunction with the movement of the switching member 47, and the biasing member 84a moves in conjunction with the movement of the biasing force transmission member 84b.

### Example of Operation of Switching Driving Depth of Screw

By operating the switching operation member 42, the screw driving machine 1B is switched between a first mode in which the driving depth of the screw 200 is set to a first driving depth and a second mode in which the driving depth of the screw 200 is set to be deeper than the first driving depth.

In the first mode, the action portion 42a is rotated in the arrow C1 direction by the operation of the switching operation member 42 by the operation portion 42b. In a state where the action portion 42a rotates in the arrow C1 direction, the first cam surface 42a1 is away from the bottom dead center position switching affected portion 85 of the lower arm 80B. Accordingly, the lower arm 80B is biased in the downward direction by the biasing member 83a and stands by in a state of moving to the first bottom dead center position P1 as illustrated in FIG. 5A.

In the state where the action portion 42a rotates in the arrow C1 direction, the second cam surface 42a2 presses the affected portion 46c of the switching member 47 in the arrow R direction. Accordingly, the switching member 47 moves in the arrow R direction. A position of the switching member 47 when the first mode is selected is referred to as a first guide position P21.

In a state where the lower arm 80 stands by at the first bottom dead center position P1 and the switching member 47 moves to the first guide position P21, the actuation portion 46b moves in a direction away from the affected portion 40c of the locking member 48. Accordingly, as illustrated in FIG. 5A, the locking member 48 moves to a locking position where the locking portion 40b protrudes to the movement path of the lower arm 80B.

In a state where the lower arm 80B stands by at the first bottom dead center position P1 and the switching member 47 moves to the first guide position P21, the transmission member 82 moves to a position where the first roller 82a is guided by the first guide groove 46a1 of the switching member 47.

In this state, the biasing force transmission member 84b is biased by the biasing member 84a, so that the position regulating portion 84e moves to a position in contact with the regulating portion 46d. When the position regulating portion 84e moves to the position in contact with the regulating portion 46d, the biasing force transmission member 84b is biased by the biasing member 84a to regulate the pressing portion 84c from further moving in the arrow R.

Accordingly, the pressing portion 84c of the biasing force transmission member 84b is away from the contacted portion 82e. Accordingly, in the state where the lower arm 80B stands by at the first bottom dead center position P1 and the switching member 47 moves to the first guide position P21, the transmission member 82 is prevented from pressing the first roller 82a against the first guide groove 46a1 by the biasing member 84a.

In order to switch from the first mode to the second mode, the bottom dead center position of the lower arm 80B is raised from the first bottom dead center position P1 illustrated in FIG. 5A to the second bottom dead center position P2 illustrated in FIG. 5B, and the locking portion 40b of the locking member 48 is caused to move to the first retracted position where the locking portion 40b is retracted from the movement path of the lower arm 80B.

Therefore, in the second mode, the action portion 42a of the switching operation member 42 is caused to rotate in the arrow C2 direction by the operation of the operation portion 42b. In addition, when the action portion 42a rotates in the arrow C2 direction, the second cam surface 42a2 presses the affected portion 46c of the switching member 47 in the arrow L direction. Accordingly, the switching member 47 moves in the arrow L direction. A position of the switching member 47 when the second mode is selected is referred to as a second guide position P22.

When the switching member 47 moves from the first guide position P21 to the second guide position P22 in the arrow L direction, the first roller 82a is pressed by the first guide groove 46a1 of the switching member 47 in the arrow L direction, and the transmission member 82 moves in the arrow L direction.

When the action portion 42a rotates in the arrow C2 direction, the first cam surface 42a1 comes into contact with the bottom dead center position switching affected portion 85 of the lower arm 80B and presses up the bottom dead center position switching affected portion 85. Accordingly, the lower arm 80B moves in the upward direction.

Thus, the switching operation member 42 causes the lower arm 80B to move in the upward direction. When the lower arm 80B moves in the upward direction, a force for moving the transmission member 82 in the upward direction via the second roller 82b and a force for moving the transmission member 82 in the arrow L direction are generated due to the inclination of the first cam groove 88a of the cam groove 88.

In contrast, the switching operation member 42 causes the transmission member 82 to move in the arrow L direction via the first roller 82a by the switching member 47 in conjunction with the movement of the lower arm 80B. Accordingly, even when the lower arm 80B moves in the upward direction, the transmission member 82 is prevented from moving in the upward direction. Accordingly, the third roller 82c is prevented from pressing the guide groove 81a of the upper arm 81 upward, and the upper arm 81 is prevented from moving upward.

Accordingly, the lower arm 80B is disengaged from the upper arm 81 via the transmission member 82 and moves in the upward direction independently of the upper arm 81. The lower arm 80B moves to the second bottom dead center position P2 as illustrated in FIG. 5B.

In the second mode, an upward movement amount of the upper arm 81 when the lower arm 80B moves to the second bottom dead center position P2 is an amount by which the upper arm 81 does not move to the operable position where the contact lever 60a of the trigger 60 is operated. Accordingly, in the second mode, the pressing member 87 operated by the upper arm 81 stands by at a position closer to the contact lever 60a than in the first mode.

Therefore, in the second mode, the movement amount of the upper arm 81 until the contact arm 8 is pressed against the driven member 300, the upper arm 81 moves to the operable position where the contact lever 60a of the trigger 60 is operated, and the upper arm 81 enters the sign-in state can be reduced as compared with a case where a position of the upper arm 81 is not changed from the first mode, and the operational feeling can be further improved.

In the screw driving machine 1B, the guide groove 81a of the upper arm 81, the cam groove 88 of the lower arm 80B, and the guide groove 46a of the switching member 47 are coupled by the transmission member 82, and the upper arm 81 is biased in the downward direction by the biasing member 83b. Further, in the screw driving machine 1B, the lower arm 80B is biased in the downward direction by the biasing member 83a, and in the second mode, in a state where the contact arm 8 is not pressed against the driven member 300, the first cam surface 42a1 of the action portion 42a comes into contact with the bottom dead center position switching affected portion 85 of the lower arm 80B, and the lower arm 80B is supported at the second bottom dead center position P2. Accordingly, in the second mode, the lower arm 80B can be fixed at the second bottom dead center position P2 even in a state where the contact arm 8 is not pressed against the driven member 300 and the second roller 82b is in contact with the middle of the first engagement portion 88c of the first cam groove 88a formed by an inclined surface of the cam groove 88.

As described above, in the state where the lower arm 80B stands by at the first bottom dead center position P1 and the switching member 47 moves to the first guide position P21, the biasing force transmission member 84b is biased by the biasing member 84a, so that the position regulating portion 84e moves to a position in contact with the regulating portion 46d. From this state, when the switching member 47 moves from the first guide position P21 to the second guide position P22 in the arrow L direction, the biasing force transmission member 84b moves in the arrow L direction in conjunction with the switching member 47. In a state where the lower arm 80B stands by at the second bottom dead center position P2 and the switching member 47 moves to the second guide position P22, the transmission member 82 moves to a position where the first roller 82a is guided by the first guide groove 46a1.

Accordingly, the pressing portion 84c of the biasing force transmission member 84b is away from the contacted portion 82e. Accordingly, in the state where the lower arm 80B stands by at the second bottom dead center position P2 and the switching member 47 moves to the second guide position P22, the transmission member 82 is prevented from pressing the first roller 82a against the first guide groove 46a1 of the guide groove 46a by the biasing member 84a.

### Operation Example of Screw Driving Machine according to Present Embodiment including Driving Depth Switching Portion of Screw

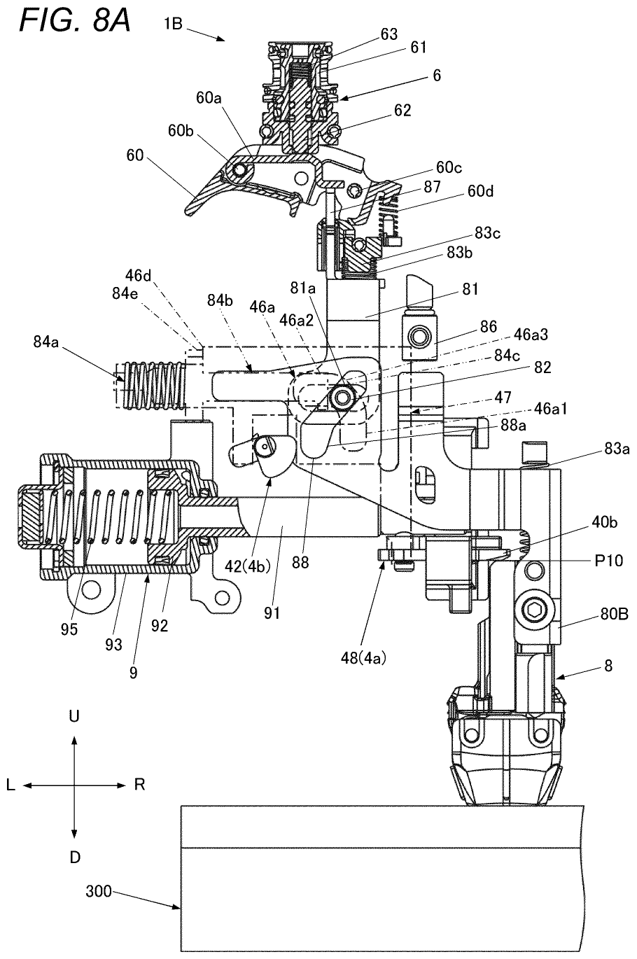

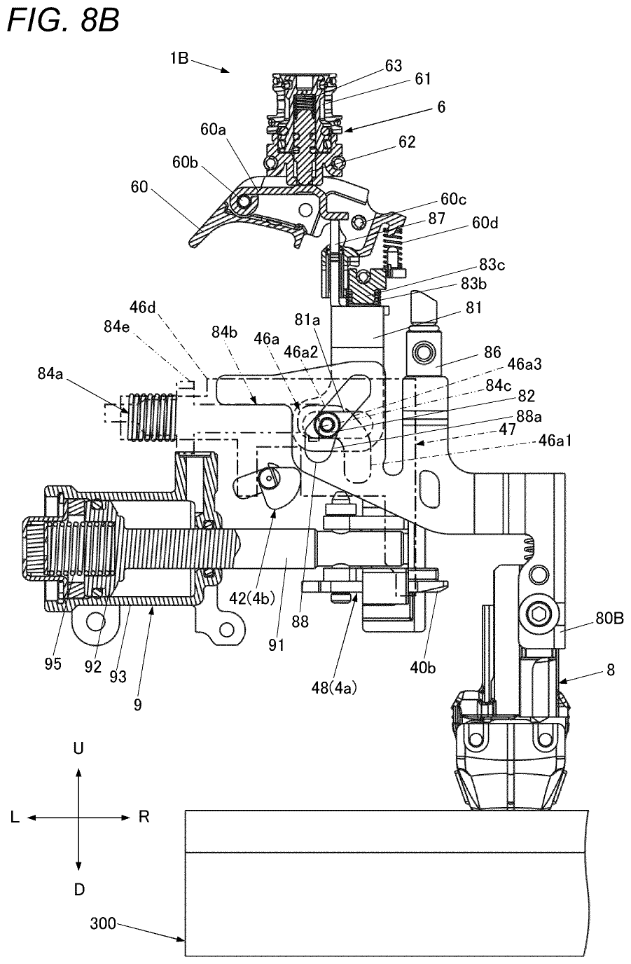

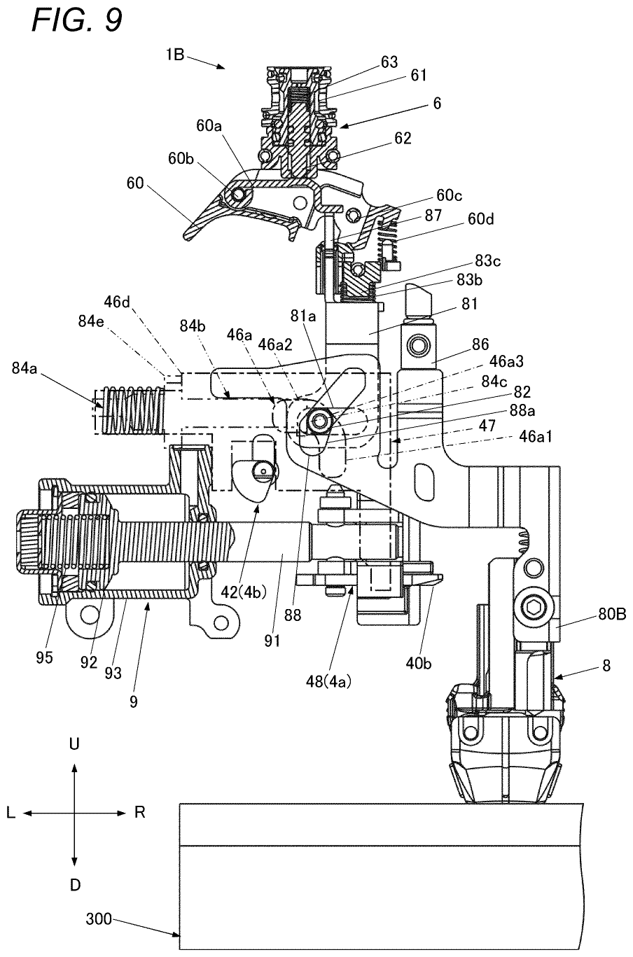

FIG. 8A and FIG. 8B are side sectional views of main parts of the screw driving machine according to the present embodiment illustrating an example of the operation of driving the screw into the driven member and tightening the screw in a state where a first mode is selected. FIG. 9 is a side sectional view of main parts of the screw driving machine according to the present embodiment illustrating an example of the operation of driving the screw into the driven member and tightening the screw in a state where a second mode is selected. Next, an example of the operation of the screw driving machine 1B in which driving and tightening of the screw 200 are performed will be described.

An operation of the screw driving machine 1B in which the first mode is selected and the driving and tightening of the screw 200 are performed is the same as that of the screw driving machine 1A.

In the state where the first mode is selected, by the operation of pressing the contact arm 8 against the driven member 300, at the position where the first roller 82a is guided by the first guide groove 46a1 until the sign-in state is reached, the position regulating portion 84e of the biasing force transmission member 84b is in contact with the regulating portion 46d, and the pressing portion 84c is away from the contacted portion 82e.

When the lower arm 80B and the upper arm 81 move in the upward direction to a position where the sign-in can be performed, the transmission member 82 moves to a position where the first roller 82a is guided by the third guide groove 46a3 as illustrated in FIG. 8A. At the position of the transmission member 82 where the first roller 82a is guided by the third guide groove 46a3, the pressing portion 84c of the biasing force transmission member 84b is away from the contacted portion 82e. Alternatively, at the position of the transmission member 82 where the first roller 82a is guided by the third guide groove 46a3, even if the pressing portion 84c of the biasing force transmission member 84b comes into contact with the contacted portion 82e, the biasing member 84a is prevented from being compressed.

Accordingly, in the state where the first mode is selected, the transmission member 82 is prevented from being pressed by the first guide groove 46a1 and the third guide groove 46a3 by the biasing member 84a by the first roller 82a until the sign-in state is reached by the operation of pressing the contact arm 8 against the driven member 300. Accordingly, the sliding resistance when the first roller 82a moves in contact with the first guide groove 46a1 and the third guide groove 46a3 is prevented. As a result, by the operation of pressing the contact arm 8 against the driven member 300, the lower arm 80B and the upper arm 81 move in the upward direction due to the relative movement with respect to the body 10, and the biasing force of the biasing member 84a is applied to the lower arm 80 and the upper arm 81 until the sign-in state is reached, and is prevented from being transmitted to the operator as a load.

As illustrated in FIG. 8B, while the lower arm 80 moves to the top dead center position, the transmission member 82 moves to a position where the first roller 82a is guided by the second guide groove 46a2. At the position where the first roller 82a is guided by the second guide groove 46a2, the pressing portion 84c of the biasing force transmission member 84b comes into contact with the contacted portion 82e, and the pressing portion 84c is pressed in the arrow L direction, so that the biasing member 84a is compressed in the arrow L direction.

When the tightening of the screw 200 is completed and the body 10 moves in a direction away from the driven member 300, the lower arm 80 moves in the downward direction from the top dead center position due to the relative movement of the body 10 and the lower arm 80B. When the lower arm 80 moves in the downward direction from the top dead center position, the second roller 82b is movable in the arrow R direction due to the inclination of the first engagement portion 88c and the second engagement portion 88d of the cam groove 88. The transmission member 82 moves in the arrow R direction with the first roller 82a guided by the second guide groove 46a2 by the biasing force caused by the extension of the biasing member 84a.

Therefore, by the operation of moving the lower arm 80 in the downward direction from the top dead center position, the first roller 82a can reliably move from the second guide groove 46a2 of the guide groove 46a to the first guide groove 46a1, and the upper arm 81 can be reliably returned to the state of moving in conjunction with the movement of the lower arm 80.

Next, an example of an operation of the screw driving machine 1A in which the second mode is selected and the driving and tightening of the screw 200 are performed will be described.

In the screw driving machine 1B, in a case where the second mode is selected, the lower arm 80B moves to the second bottom dead center position P2 as described above. The locking member 48 moves to the first retracted position where the locking portion 40b is retracted from the movement path of the lower arm 80 by the movement of the switching member 47.

In a state where the second mode is selected as described above, the operator holds the handle 11 of the screw driving machine 1B and presses the contact arm 8 against the driven member 300. In the screw driving machine 1B, when the contact arm 8 is pressed against the driven member 300, the lower arm 80B moves in the upward direction due to the relative movement with respect to the body 10.

While the lower arm 80B moves to the second bottom dead center position P2, the transmission member 82 moves to a position where the first roller 82a is guided by the first guide groove 46a1. Accordingly, when the lower arm 80B moves in the upward direction from the second bottom dead center position P2 due to the relative movement with respect to the body 10, the second roller 82b is pressed by the cam groove 88 of the lower arm 80B, and the first roller 82a is guided by the first guide groove 46a1 of the guide groove 46a of the switching member 47, whereby the transmission member 82 moves in the upward direction.

When the transmission member 82 moves in the upward direction, the guide groove 81a of the upper arm 81 is pressed upward. Accordingly, the upper arm 81 moves in the upward direction as indicated by the arrow U in conjunction with the lower arm 80B.

When the lower arm 80B and the upper arm 81 move in the upward direction due to the relative movement with respect to the body 10, the lower arm 80B moves in the upward direction beyond the locking member 48 moved to the first retracted position.

When the lower arm 80B moves to the top dead center position, as illustrated in FIG. 9, the upper arm 81 moves to an operable position where the contact lever 60a of the trigger 60 is operated. When the upper arm 81 moves to the operable position, the upper arm 81 comes into contact with the support convex portion 83c to which the biasing member 83b is attached.

In a case where the second mode is selected, when the upper arm 81 moves to the operable position, the lower arm 80B moves to the top dead center position, and an operation of pulling the trigger 60 is performed, the start valve 6 is brought into a sign-in state where the start valve 6 is operated.

In the state where the second mode is selected, by the operation of pressing the contact arm 8 against the driven member 300, the position regulating portion 84e of the biasing force transmission member 84b is in contact with the regulating portion 46d and the pressing portion 84c is away from the contacted portion 82e until the sign-in state is reached. When the lower arm 80B moves to the top dead center position, the transmission member 82 moves to a position where the first roller 82a is guided by the third guide groove 46a3. At the position of the transmission member 82 where the first roller 82a is guided by the third guide groove 46a3, the pressing portion 84c of the biasing force transmission member 84b is away from the contacted portion 82e. Alternatively, at the position of the transmission member 82 where the first roller 82a is guided by the third guide groove 46a3 of the guide groove 46a, even if the pressing portion 84c of the biasing force transmission member 84b comes into contact with the contacted portion 82e, the biasing member 84a is prevented from being compressed.

Accordingly, in the transmission member 82, the first roller 82a is prevented from being pressed by the biasing member 84a into the first guide groove 46a1 and the third guide groove 46a3, and the sliding resistance when the first roller 82a moves in contact with the first guide groove 46a1 and the third guide groove 46a3 is reduced. Accordingly, even in a state where the second mode is selected, by the operation of pressing the contact arm 8 against the driven member 300, the lower arm 80B and the upper arm 81 move in the upward direction due to the relative movement with respect to the body 10, and the biasing force of the biasing member 84a is applied to the lower arm 80B and the upper arm 81 until the sign-in state is reached, and is prevented from being transmitted to the operator as a load.

When the start valve 6 is operated, the compressed air is supplied to the driving cylinder 30 by operating the main valve 5 as described above, and the screw 200 supplied to the injection passage 12a is driven into the driven member 300 by moving the driving piston 30a in the downward direction from the top dead center position.

When the driving piston 30a moves in the downward direction from the top dead center position, the feeding member 91 coupled to the feed piston 92 moves in the arrow L direction, so that the locking member 48 attached to the feeding member 91 moves in the arrow L direction. Accordingly, the locking member 48 moves to the second retracted position while moving to the first retracted position.

When the main valve 5 is operated, compressed air is supplied to the air motor 31, the driver bit 2 rotates, and the screw 200 driven into the driven member 300 is tightened. In addition, by the operation of pressing the contact arm 8 against the driven member 300, the body 10 further moves in the downward direction following the tightening of the screw 200.

As described above, in a case where the second mode is selected, when the lower arm 80B moves to the top dead center position, a sign-in state can be reached, and the driving piston 30a starts moving in the downward direction. The on-off valve 7 is configured not to operate until the driving piston 30a moves in the downward direction by a predetermined distance.

When the driving piston 30a moves in the downward direction by the predetermined distance, the on-off valve 7 is operated as described above, and the supply of the compressed air to the air motor 31 is stopped. When the supply of the compressed air to the air motor 31 is stopped, rotation of the driver bit 2 is stopped.

When the rotation of the driver bit 2 is stopped and the tightening of the screw 200 is completed, the operator weakens the force for pressing the contact arm 8 against the driven member 300 and moves the body 10 in a direction separating from the driven member 300.

When the body 10 moves in the direction away from the driven member 300, the lower arm 80B moves in the downward direction from the top dead center position by the biasing of the biasing member 83a due to the relative movement of the body 10 and the lower arm 80B.

In a case where the second mode is selected, in a state where the lower arm 80B moves to the top dead center position, as described above, the transmission member 82 moves to a position where the first roller 82a is guided by the third guide groove 46a3. At the position of the transmission member 82 where the first roller 82a is guided by the third guide groove 46a3 of the guide groove 46a, the force of the biasing member 84a pressing the transmission member 82 in the arrow R direction via the biasing force transmission member 84b is not applied.

However, since the transmission member 82 moves to the position where the first roller 82a is guided by the third guide groove 46a3 of the guide groove 46a, when the lower arm 80B moves in the arrow D direction from the top dead center position, the transmission member 82 moves in the arrow R direction with the first roller 82a guided by the third guide groove 46a3 due to the inclination of the cam groove 88 of the lower arm 80B.

Accordingly, in a state where the second mode is selected, the first roller 82a can reliably move from the third guide groove 46a3 to the first guide groove 46a1 by the operation of moving the lower arm 80B in the downward direction from the top dead center position.

When the first roller 82a moves from the third guide groove 46a3 to the first guide groove 46a1, the transmission member 82 is movable in the downward direction while been guided by the first guide groove 46a1. Accordingly, the upper arm 81 moves in the downward direction due to the relative movement with respect to the body 10 following the lower arm 80B by the biasing of the biasing member 83b.

When the upper arm 81 moves in the downward direction, the pressing of the contact lever 60a is released, and the contact lever 60a is away from the start valve 6. When the contact lever 60a is away from the start valve 6, the main valve 5 closes, and the driving piston 30a moves to the top dead center position by the air pressure in the blowback chamber 33. When the driving piston 30a moves to the top dead center position, the feeding member 91 coupled to the feed piston 92 moves in the arrow R direction by the biasing of the biasing member 94a.

When the feeding member 91 moves in the arrow R direction, a feeding claw (not illustrated) provided on the feeding member 91 feeds a next screw 200 to the injection passage 12a. In addition, the locking member 48 attached to the feeding member 91 moves in the arrow R direction. Accordingly, the locking member 48 moves from the second retracted position to the first retracted position.

What is claimed is:

1. A screw driving machine comprising:
a driving portion to which compressed air is supplied and configured to cause a driver bit to move in an axial direction of the driver bit;
a tightening portion to which the compressed air is supplied and configured to cause the driver bit to rotate around an axis;
a main valve configured to switch whether the compressed air is supplied to the driving portion and the tightening portion;
a start valve that causes the main valve to operate;
a first arm supported movably along the axial direction of the driver bit and configured to come into contact with a driven member;
a second arm supported movably along the axial direction of the driver bit and configured to cause the start valve to operate;
a transmission member configured to move to a position where movement of the first arm can be transmitted to the second arm and the first arm moves in conjunction with the second arm, and move to a position where the movement of the first arm is not transmitted to the second arm to release conjunction between the first arm and the second arm;
a guide portion configured to guide movement of the transmission member and switch whether the first arm moves in conjunction with the second arm in accordance with a position of the transmission member that is being guided;
a biasing member configured to bias the transmission member toward a position where the movement of the first arm can be transmitted to the second arm; and
a biasing force switching portion configured to regulate a biasing force of the biasing member against the transmission member and switch a strength of the biasing force of the biasing member in accordance with a position of the transmission member guided by the guide portion.

2. The screw driving machine according to claim 1, wherein
the biasing force switching portion includes:
a biasing force transmission member configured to transmit the biasing force of the biasing member to the transmission member; and
a regulating portion configured to regulate a position of the biasing force transmission member.

3. The screw driving machine according to claim 2, wherein
the transmission member includes a roller.

4. The screw driving machine according to claim 2, wherein
the guide portion includes:
a first guide groove including a position at which the movement of the first arm can be transmitted to the second arm and configured to guide the transmission member in a first direction in which the first arm moves in conjunction with the second arm; and
a second guide groove including a position at which the movement of the first arm is not transmitted to the second arm and configured to guide the transmission member in a second direction in which the conjunction between the first arm and the second arm is released, and
the biasing force switching portion weakens the biasing force of the biasing member against the transmission member guided by the first guide groove than the biasing force of the biasing member against the transmission member guided by the second guide groove.

5. The screw driving machine according to claim 4, wherein
the biasing force switching portion releases transmission of the biasing force of the biasing member against the transmission member guided by the first guide groove.

6. The screw driving machine according to claim 4, further comprising:
a driving depth regulating portion configured to restrict a movement amount of the first arm and restrict a driving depth of a screw by the driving portion; and
a driving depth switching portion configured to switch whether the movement amount of the first arm is restricted by the driving depth regulating portion and move the transmission member via the guide portion in conjunction with switching of whether the movement amount of the first arm is restricted, wherein
the biasing force switching portion and the biasing member move in conjunction with movement of the guide portion.

7. The screw driving machine according to claim 4, wherein
the first guide groove extends in a direction parallel to the first direction,
the second guide groove extends in a direction parallel to the second direction, and
the biasing member is disposed to extend in the direction parallel to the second direction.
